(19) United States
(12) Patent Application Publication
(10) Pub. No.: US 2003/0069757 A1
(43) Pub. Date: Apr. 10, 2003

(54) Systems and methods for designing and delivering a nutritional supplement regime

(76) Inventor: Sanford Greenberg, Cherry Hills Farm Village, CO (US)

Correspondence Address: FISH & NEAVE, 1251 AVENUE OF THE AMERICAS, 50TH FLOOR, NEW YORK, NY, 10020-1105, US

(21) Appl. No.: 10/265,537

(22) Filed: Oct. 4, 2002

Related U.S. Application Data
(60) Provisional application No. 60/327,536, filed on Oct. 5, 2001.

(51) Int. Cl. G06F 17/60; G09B 19/00

(52) U.S. Cl. 705/2; 434/127

(57) ABSTRACT

Systems and methods for designing and delivering a nutritional supplement regime are provided. The nutritional supplement regime may include, for example, various nutritional supplements which are commonly available over-the-counter. Each nutritional supplement may be directed towards a specific problem, deficiency, or activity of the individual. The individual may provide information in connection with his or her specific problems, deficiencies, or activities by, for example, completing a questionnaire. The individual may access the questionnaire using a communications network such as, for example, the Internet. The nutritional supplements may be assembled into a kit which may be delivered to the individual at an appropriate time.

This application claims the benefit of U.S. provisional patent application No. 60/327,536, filed Oct. 5, 2001, which is hereby incorporated by reference herein in its entirety.

### BACKGROUND OF THE INVENTION

The present invention relates to systems and methods for designing and delivering a nutritional supplement regime. More particularly, the present invention relates to systems and methods for designing and delivering a nutritional supplement regime that incorporates, for example, nutritional supplements which are commonly available over-the-counter.

The importance of optimal nutrition as a component of any healthy lifestyle cannot be over emphasized. Unfortunately, the human body is unable to store all of the nutrients that it needs to maintain optimal strength and health. Further, it is often impossible to maintain a proper nutritional balance merely through normal diet. In some individuals, poor health or an active lifestyle, for example, may make the nutritional needs of the individual not only greater than those of the average individual, but also more distinct and specific with respect to the quantities of individual nutritional factors required for optimal strength and health.

In response to this problem, many health-oriented companies produce over-the-counter nutritional supplements which can be purchased in, for example, health food or vitamin stores. Currently, it is possible to buy a wide range of nutritional supplements in this way such as, for example, minerals, amino acids, fatty acids, proteins, carbohydrates, fiber, herbs, vitamins, and other nutritional factors. However, the difficulty of designing an optimized nutritional supplement regime on an individualized basis and the necessity to purchase multiple bottles of nutritional supplements in order to follow the regime are examples of some of the burdens associated with this method. Additional burdens on the individual can be caused by, for example, fear that the nutritional supplements will pass their expiration dates before use, embarrassment of interacting with an employee at a health food or vitamin store, or annoyance at having to take the time out of the day. Further burdens can be caused by, for example, fear of unwanted interactions between nutritional supplements or ignorance as to combining nutritional supplements in an effective way. Finally, for individuals with allergies or athletes who are banned from ingesting specific substances, it is an additional burden to determine the ingredients of the nutritional supplements such that undesired substances are avoided. The burdens described hereinabove may prove prohibitive in terms of, for example, time, cost, convenience, storage space, knowledge base, and guidance.

The United States government, in recognition of the importance of good nutrition, commissions the publication of a Recommended Daily Allowance (“RDA”), which is a summary of amounts of many nutrients that are required in a healthy diet. However, in practice, this information provided by the government can be difficult to use and is sometimes in conflict with, for example, published articles or other information made available to the public. Adding to the confusion is the fact that the nutritional needs of active individuals (e.g., athletes), sick individuals, or individuals inhabiting a specific type of climate or environment may vary greatly from the RDA. The RDA is, by definition, the minimum amount of a nutrient required to prevent a deficiency of that nutrient. Partly as a result of the confusion described hereinabove and the general difficulty of following or otherwise fulfilling the dietary recommendations, it has been estimated that only 9% of the U.S. population gets the RDA of nutrients.

Exacerbating the need for nutritional supplementation in some cases is the fact that, in some cases, the nutritional content of food may be decreasing. The reduction in nutrients may be caused, for example, by changes in farming technology and plant genetics. In addition, processing of foods for convenience as well as modern cooking techniques have resulted in nutrient losses from foods. Over the past ten years, a significant amount of research has been published to validate the ingestion of vitamins and minerals in nutritional supplements to make up for the nutrient losses in today's food.

Thus, with all of the stresses that a human body goes through during daily activities and exercise, it is important that the body receives the proper nutrients. Without a sufficient amount of nutrients, the body may weaken and become more susceptible to injury, sickness, and trauma. Eating the right foods, along with proper nutritional supplementation and maintenance of a positive mental attitude, can make a substantial difference in energy level, stamina, and strength. However, as described above, obstacles to design and delivery of nutritional supplement regimes may stand in the way of consumers benefiting from nutritional supplements with maximum efficiency and convenience.

Containers or storage organizers capable of holding multiple objects are known in the art. With respect to storage organizers or containers available for use in delivery systems, Brown et al. U.S. Pat. No. 5,915,553 (which is hereby incorporated by reference herein in its entirety), for example, describes flexible organizers.

Systems and methods for administering or delivering prescription medications have developed to meet some of the needs of individuals requiring such a service. For example, Shoenfeld U.S. Pat. No. 6,189,727 (which is hereby incorporated by reference herein in its entirety) is directed towards a semi-automated pharmaceutical dispensing arrangement which has a drug cabinet in which a control mechanism permits opening of the front door by an authorized attendant, permitting the attendant to obtain pre-filled bottles or containers of medication for a patient's prescription order. In another example, Broselow U.S. Pat. No. 6,132,416 (which is hereby incorporated by reference herein in its entirety) is directed towards a method of determining the proper prescription medication dosage for a patient, including the steps of correlating a plurality of dosages of a plurality of medications to respective weight-related values. In yet another example, Sahai et al. U.S. Pat. No. 5,971,594 (which is hereby incorporated by reference herein in its entirety) is directed towards a prescription medication dispensing system comprising an on-site medication dispensing unit and a central monitoring facility.

In a further example, Portwood et al. U.S. Pat. No. 5,950,630 (which is hereby incorporated by reference herein in its entirety) is directed towards a system and method for improving compliance by a patient with a medical regimen that has been prescribed to the patient. By utilizing computer and electronic communication systems, patient data is compared to pharmaceutical data to verify whether prescribed medication dosage and prescribed medication duration are within acceptable limits. Any abnormalities found by the comparisons are reported to the treating physician, who may then alter the medical regimen before authorizing the dispensing of the prescribed medication and provide drug-taking information to the patient. In yet a further example, Cousin U.S. Pat. No. 5,646,912 (which is hereby incorporated by reference herein in its entirety) is directed towards a medication compliance, coordination, and dispensing system for coordinating the administration of medication regimens at a home equipped with a system for monitoring patient compliance and protecting the patient from overdosage and underdosage. In still a further example, Garcia U.S. Pat. No. 6,088,429 (which is hereby incorporated by reference herein in its entirety) is directed towards interactive prescription medication data systems and methods which include automated means for providing information pursuant to telephonic and electronic requests from callers.

Because the systems and methods of the art described hereinabove are related to prescription medication, they are therefore directed towards, for example, the problems of compliance, dosing, and regulatory issues regarding the dispensing of controlled substances. However, these issues are not applicable with respect to this invention. The systems and methods of the art, if anything, place additional burdens on the consumer of over-the-counter nutritional supplements. The systems and methods described hereinabove are also generally directed towards one prescription medication and do not have the capability to design medication regimens for an individual based on personal information provided by the individual.

In fact, there has been little attention paid to systems and methods for designing and delivering nutritional supplement regimes which incorporate, for example, nutritional supplements and other products which are commonly available over-the-counter. Therefore, the problems discussed hereinabove with respect to nutritional deficiencies in humans remain in many instances unsolved.

Accordingly, it would be desirable to provide systems and methods for designing and delivering a nutritional supplement regime.

### SUMMARY OF THE INVENTION

In accordance with the present invention, systems and methods for designing a customized nutritional supplement regime and delivering the customized nutritional supplement regime to an individual are provided.

In some embodiments of the present invention, information from the individual may be received. At least a portion of the information may concern personal information about the individual. A nutritional supplement regime may be created that includes a plurality of nutritional supplements that are selected based on the information received from the individual. The nutritional supplement regime may be provided to the individual.

In some of these embodiments, the individual may be provided with a questionnaire. Information as inputted into the questionnaire by the individual may be received. The individual may be allowed to access the questionnaire via, for example, the Internet or a public switched telephone network.

In some of these embodiments, an interview may be conducted with the individual. Information as provided during the interview by the individual may be received. The interview may be conducted, for example, over the telephone.

In some of these embodiments, the nutritional supplement regime may be provided to the individual in a case. The case may include a cover, a compartment, and a plurality of partitions that separate the compartment into a plurality of chambers. Each nutritional supplement of the plurality of nutritional supplements may be held in a chamber of the plurality of chambers.

In some of these embodiments, the information received from the individual may concern, for example, nutritional habits, exercise habits, health information, or personal goals of the individual.

### BRIEF DESCRIPTION OF THE DRAWINGS

FIG. 1 is a schematic diagram of an illustrative system suitable for implementation of a nutritional supplement questionnaire application in accordance with the present invention.

FIG. 2 is a generalized schematic diagram of an illustrative workstation in accordance with the present invention.

FIG. 3 is an illustrative introductory display screen that may be provided to an individual by the nutritional supplement questionnaire application in accordance with the present invention.

FIG. 4 is an illustrative personal information display screen that may be provided to the individual by the nutritional supplement questionnaire application in accordance with the present invention.

FIG. 5 is an illustrative nutritional habits display screen that may be provided to the individual by the nutritional supplement questionnaire application in accordance with the present invention.

FIG. 6 is an illustrative exercise habits display screen that may be provided to the individual by the nutritional supplement questionnaire application in accordance with the present invention.

FIG. 7 is an illustrative health information display screen that may be provided to the individual by the nutritional supplement questionnaire application in accordance with the present invention.

FIG. 8 is another illustrative health information display screen that may be provided to the individual by the nutritional supplement questionnaire application in accordance with the present invention.

FIG. 9 is an illustrative personal goals display screen that may be provided to the individual by the nutritional supplement questionnaire application in accordance with the present invention.

FIG. 10 is an elevational view of a case for holding nutritional supplements in accordance with the present invention.

FIG. 11 is a sectional view of the case of FIG. 10 taken along line 1040-1040 in accordance with the present invention.

FIG. 12 is a side view of the case of FIG. 10 illustrating the opening and closing of the case in accordance with the present invention.

FIG. 13 is an elevational view of a portion of the case of FIG. 10 illustrating the removal of a partition in accordance with the present invention.

FIG. 14 is a sectional view illustrating the partition as removed from the case of FIG. 13 in accordance with the present invention.

### DETAILED DESCRIPTION OF THE PREFERRED EMBODIMENTS

In accordance with the present invention, systems and methods for designing and delivering a nutritional supplement regime are provided.

In some embodiments of the present invention, an individual may enter data. The data entered by the individual may be recorded and analyzed. The data may be correlated with a nutritional supplement regime which corresponds to parameters set by the entered data.

In some embodiments of the present invention, an individual may create a “personal profile,” thereby both entering and recording data. The personal profile may be inputted, for example, by using a computing device, by hand, by using a telephone, by providing the information in person to a practitioner, or by any using other suitable manner of inputting the data. The individual may supply personal information, goals, limitations, and any other suitable personal information. The information is then analyzed by, for example, a computing device, a human being (e.g., a practitioner), or both. A nutritional supplement regime, to be delivered in a personalized organizer, for example, may be designed for the individual.

In some embodiments of the present invention, the information described hereinabove may be inputted on a questionnaire by, for example, answering in essay form a series of questions or selecting multiple choice responses. In embodiments such as these, for example, the questionnaire may be completed by hand, by computer, or verbally. Possible information requested by the questionnaire may be related to categories such as height, weight, medical history, injuries, exercise experience, goals, past experience with nutritional supplements, or any other suitable personal information. In some embodiments of the present invention, the questionnaire may include open-ended questions requesting comments from the individual.

In some embodiments of the present invention, the questionnaire may be completed during an interview. The interview may be conducted, for example, in person or over the phone. During the interview, specific questions are asked by an operator, a consultant, a practitioner, a store owner, etc., who then fills out a questionnaire based on comments and responses made during the interview.

The personal profile may be used, for example, by a team of nutritionists, doctors, and/or fitness experts to better understand the needs of the individual and therefore recommend a nutritional supplement regime. Such a profile could be used, for example, to correlate the individual's needs to nutritional supplements developed to address the needs of the individual. The nutritional supplements may allow the individual's nutritional needs to be met and may allow, for example, creation of a nutritional supplement regime on an individualized basis. A human being may create the nutritional supplement regime or, with the appropriate software, a computing device may create the nutritional supplement regime based on the information provided in the personal profile. Such software can easily be designed by one of skill in the art in light of the present disclosure.

The nutritional supplement regime of the present invention addresses all of the body's functions, and provides an abundance of the nutritional fundamentals, such as vitamins, minerals, amino acids, essential fatty acids (“EFAs”), proteins, and other cofactors which the body may not be able to manufacture on its own. An elite athlete, for example, who does not supply his or her body with an abundance of these essential nutrients daily, may experience deficiencies. These deficiencies may or may not manifest themselves in the form of a debilitating disease. However, it is possible that the deficiencies will hinder optimal recovery, health, and performance. The elimination of deficiencies of macro- or micro-nutrients in the individual is a positive result that the systems and methods of the present invention seek to achieve.

The systems and methods of the present invention allow an individual to recover more quickly from training and competition and allow the individual's body to respond positively to the appropriate exercise stimulus.

In some embodiments of the present invention, scientists, biochemists, nutritionists, pharmacists, or any other suitable person skilled in nutrition may work in conjunction with an individual, professional strength coaches, or health care professionals, for example, to determine what is best for the individual.

In some embodiments of the present invention, an exercise program specialized and designed to be used in conjunction with a specific nutritional supplement regime may be included. For example, an individual may input his or her physical dimensions, goals, and any other relevant information. The information may then be analyzed by, for example, a computing device or a human being such as a specialist to formulate an accompanying exercise program to be used with the nutritional supplements supplied by the regime. In some of these embodiments, the exercise program may be augmented on a timely basis along with the augmentation of the individual's nutritional supplement dosage. The timing for such augmentation may be, for example, as the individual gradually improves his or her health and performance through the nutritional supplement regime.

In some embodiments of the present invention, a nutritional supplement kit may be shipped, for example, directly to the individual, to a retail store, or to the individual's fitness club for pick-up. The kit may be prepared at the store or at a production facility. In some of these embodiments, the kit could be recycled by the individual by sending it back when empty. An incentive for the individual to recycle the kit may be provided by, for example, a reduced cost of the next kit purchased by the individual, etc.

Possible delivery schedules for the kit may include, for example, bi-monthly, monthly, semimonthly, weekly, semi-weekly, daily, or any other schedule suitable to meet the needs of the individual.

In some embodiments of the present invention, the kit may be assembled in a case, or a cube-design storage organizer. Placards may be included in the case to organize nutritional supplements and to help remind an individual, for example, when a nutritional supplement should be taken during a day. Placards are especially useful when there are disparate numbers of nutritional supplements that have to be taken with other supplements in different dosages or at different times of the day.

In some embodiments of the present invention, the nutritional supplement regime may be designed to achieve a specific goal. For example, there may be a “basic” regime for novices to nutritional supplement regimes. Such a regime is designed taking into account the body's need to become acclimated to a nutritional supplement regimen. In another example, there may be an “essential” regime for intermediate-level, active individuals. Such a regime is designed taking into account the nutritional balance needed for the individual's level of activity without bombarding the body with unnecessary levels of nutrients. In yet another example, there may be an “elite” regime for high-performance athletes and fitness enthusiasts. Such a regime is designed taking into account the level of supplementation necessary for individuals acclimated to higher dosages of nutrients for the grueling demands placed on their bodies. For example, the elite regime may be designed to address the needs of a marathon runner with a lighter body weight and high degree of cardiovascular requirements. In another example, the elite regime may be designed for a competitor in the shot put, or a professional football lineman, whose body type calls for dense muscle mass and body size, and whose training requires an elite formulation of nutritional supplements addressing those needs.

In yet another example, there may be a “youth” regime for grade school, high school, or college athletes whose needs must be specifically addressed according to their age and/or individual degree of growth.

In yet another example, there may be goal-specific regimes addressing, for example, the specific needs of individuals of advanced or middle age or individuals desiring to gain or lose body mass.

In some embodiments of the present invention, included in the nutritional supplement regime may be food replacement, such as a sports shake, meal replacement bar, sports drink, chewing gum, snack food, breakfast bar, energy gel, protein powder, herbs, recipes for food designed to complement a specific regime, or any other food-related item.

In some embodiments of the present invention, selected periodicals or literature designed to supplement an individual's current nutritional supplement regime may be provided. For example, a competitive runner might receive literature regarding medical developments, supplementation, state of the art information, competitions, or articles of interest specifically designed to appeal to competitive runners. In another example, the literature may be inspirational or encouraging in nature. In yet another example, the literature may be specifically selected for a novice athlete or newcomer to fitness. In still another example, the literature may be specifically selected to appeal and pertain to an individual within a particular age group.

In some embodiments of the present invention, the case in which the nutritional supplements are delivered may be altered to include compartments for perishable items, such as whole herbs or roots selected specifically for the individual's regime.

In some embodiments of the present invention, the case in which the nutritional supplements are delivered may be altered to include compartments for prescription drugs that the individual is currently taking.

In some embodiments of the present invention, the case may be altered to include compartments for specially-selected merchandise. Such merchandise may include, for example, items which are worn down or replaced frequently in a particular individual's specialized exercise regime. Specifically, such merchandise may include, for example, socks which become worn down in running, chalk used in heavy lifting exercises, gloves quickly worn away in sports such as racquetball, golf, or baseball, or any other suitable merchandise. Such merchandise may also include one-time delivery of items for use in a particular exercise regime. Such merchandise may be promotional in nature. For example, merchandise may include T-shirts, shorts, weight training gloves, goggles, sunglasses, bags, towels, thermoses, or any other suitable merchandise that includes an advertisement (e.g., a provider logo).

In some embodiments of the present invention, the nutritional supplement regime may be automatically modified as seasons change or athletic training changes based on, for example, predetermined parameters at the beginning of the time period (e.g., year).

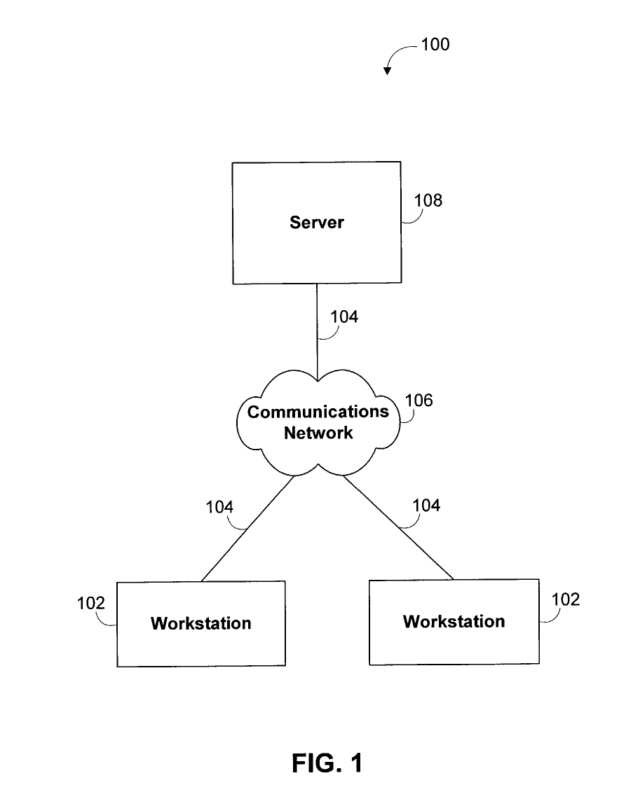

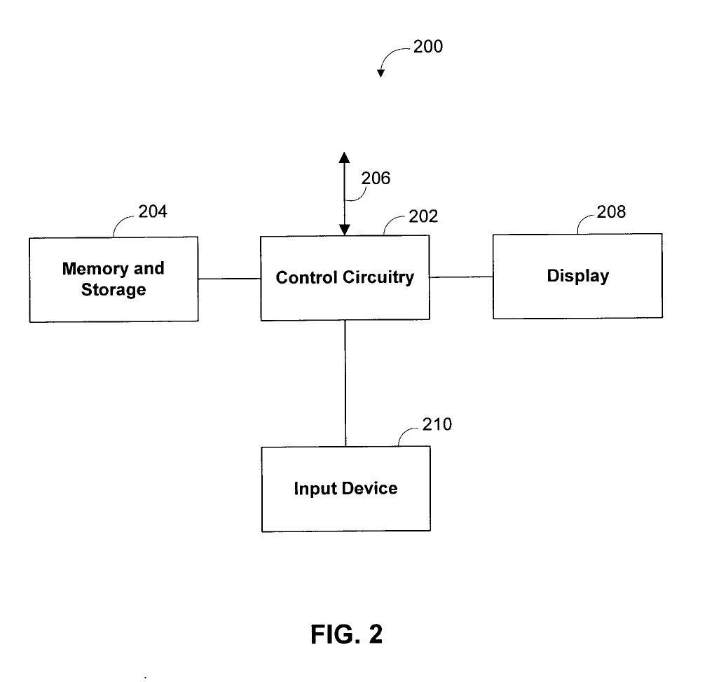

As described hereinabove, an individual may input a personal profile into a questionnaire. Such a questionnaire may be completed by using, for example, a computing device. An illustrative system for allowing an individual to input personal information into a questionnaire such that the information is accessible for analysis is provided in FIGS. 1 and 2. It should be noted, however, that the system of FIGS. 1 and 2 is merely illustrative. As described hereinabove, an individual may complete a questionnaire verbally over the telephone, in person, by hand using a paper and pen or pencil, or in any other suitable manner.

FIG. 1 is a schematic diagram of an illustrative system 100 suitable for implementation of a nutritional supplement questionnaire application in accordance with the present invention. System 100 may be used to design and deliver a nutritional supplement regime based on information received from one or more individuals. Workstations 102 may be connected via communications links 104 to communications network 106. Workstations 102 may include, for example, any suitable personal computer (PC), portable computer (e.g., a notebook computer), palmtop computer, handheld personal computer (H/PC), automobile PC, personal digital assistant (PDA), Internet-enabled cellular phone, combined cellular phone and PDA, any other suitable computing device, or a combination of such devices. In practice, there may be many workstations 102, but only two have been shown to avoid overcomplicating the drawing. Communications network 106 may be any suitable communications network including the Internet, an Intranet, a wide-area network (WAN), a local-area network (LAN), a wireless network, a digital subscriber line (DSL) network, a frame relay network, an asynchronous transfer mode (ATM) network, a virtual private network (VPN), a public switched telephone network, or a combination of such networks.

Server 108 may be any server suitable for providing access to the nutritional supplement questionnaire application. Server 108 may, for example, provide the nutritional supplement questionnaire application to workstations 102 using one or more suitable protocols (e.g., the HyperText Transfer Protocol (HTTP) and Transmission Control Protocol/Internet Protocol (TCP/IP)). Nutritional supplement questionnaire application pages may be defined using, for example, any suitable markup language (e.g., HyperText Markup Language (HTML), Dynamic HyperText Markup Language (DHTML), Extensible Markup Language (XML), JavaServer Pages (JSP), Active Server Pages (ASP), or any other suitable approaches). The pages may include scripts, computer code, or subsets of computer code that define mini-programs (e.g., Perl scripts, Java applets, Enterprise JavaBeans (EJB), or any other suitable approaches). The nutritional supplement questionnaire application may be designed using modular approaches such as, for example, Java 2 Platform Enterprise Edition (J2EE), Component Object Model (COM), Distributed Component Object Model (DCOM), or any other suitable approach. In practice, features of server 108 may be integrated into a single server as shown, or may be distributed across multiple servers that are interconnected via communications network 106.

Communications links 104 may include, for example, a dial-up telephone line, a computer network or Internet link, an infrared link, a radio frequency link, a satellite link, a digital subscriber line link (e.g., a DSL link), a cable TV link, a DOCSIS link, or any other suitable transmission link or combination of such communications links. Communications links 104 may be of different types depending on, for example, the particular type of workstation 102 to which the communications link is connected.

Any protocol or protocol stack suitable for supporting communications between workstations 102 and communications network 106 over communications links 104 may be used. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of such protocols may be used.

In embodiments involving platforms other than personal computers, modified versions of display screens may be used. For example, content for nutritional supplement questionnaire application displays may be formatted or stripped from displays by communications network 106 to make the displays appropriate for workstations 102 that are not personal computers. Alternatively, display screen pages may be constructed by communications network 106 depending on an individual's workstation 102.

A generalized schematic diagram of a workstation, such as workstation 102, is shown in FIG. 2.

FIG. 2 is a schematic diagram of an illustrative workstation 200. Control circuitry 202 and memory and storage 204 may have communications, memory, and processing circuitry suitable for processing functions and accessing the nutritional supplement questionnaire application over communications line 20G. Communications line 206 may be coupled to communications link 104 of FIG. 1. Text and graphics (e.g., display screens) associated with the nutritional supplement questionnaire application may be presented to an individual using a display 208. Display 208 may be a computer monitor, a handheld computer display, a laptop computer display, a personal digital assistant display, or any other suitable display equipment.

The user may interact with control circuitry 202 using any suitable input device 210, such as a keyboard, a wireless keyboard, a mouse, a trackball, a touch pad, or any other suitable input device.

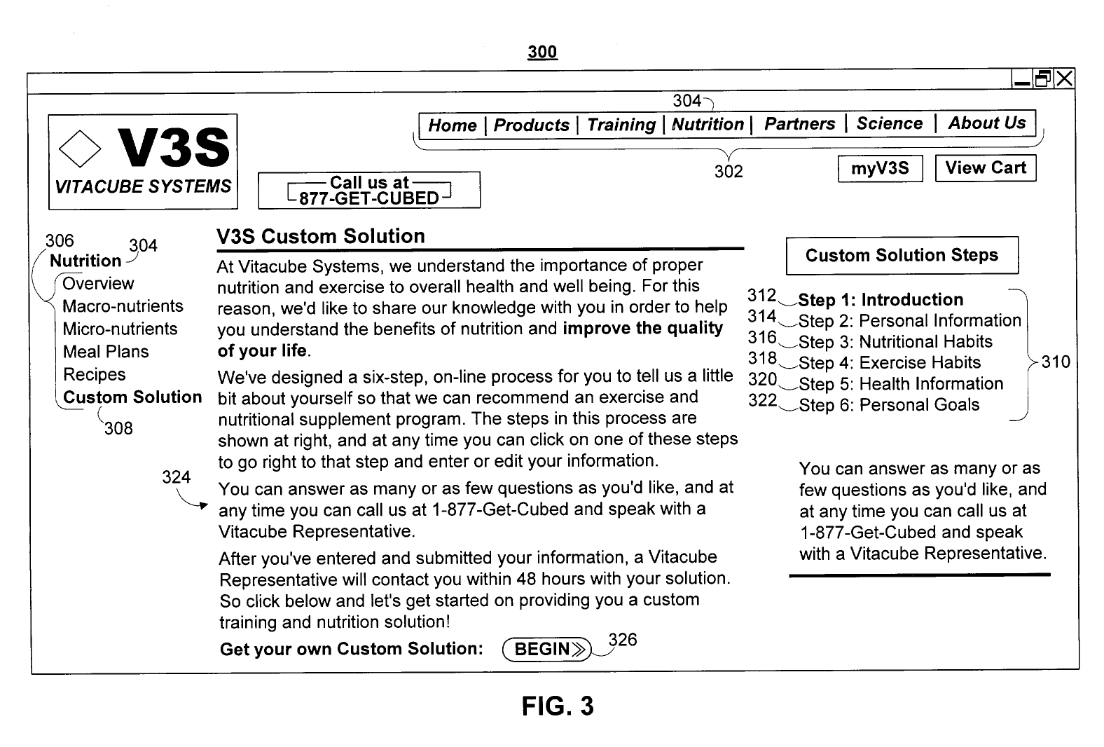

FIGS. 3-9 show illustrative display screens (e.g., Web pages), or portions of display screens, for designing and delivering a nutritional supplement regime in accordance with this invention. The display screens of FIGS. 3-9 are merely illustrative. Any other suitable user interface elements for providing the features therein may be used. For example, selectable areas, buttons, drop-down lists, fields for entering text, and any other user interface elements may be interchanged with the elements shown in the various figures to provide various features. In addition, the display screens of FIGS. 3-9 are described herein as being “provided” by the nutritional supplement questionnaire application. This is intended to include any suitable approach for generating displays that include nutritional supplement information received over a communications network, such as communications network 106, from a remote source, such as server 108 (FIG. 1). This may include, for example, mark-up language-based approaches where a Web browser running on workstation 102 (FIG. 1) is used to interface with the nutritional supplement questionnaire application, approaches where displays are remotely generated and downloaded for direct display, or any other suitable approach.

FIG. 3 shows an illustrative introductory display screen 300 that may be provided by the nutritional supplement questionnaire application in accordance with the present invention. The nutritional supplement questionnaire application may provide introductory display screen 300 to an individual in response to receiving the individual's request to access nutritional supplement information.

Introductory display screen 300 may include menu region 302. Menu region 302 may be included in one or more other display screens of the present invention. Menu region 302 may include a list of selectable options in connection with various features provided by the nutritional supplement questionnaire application. For example, as shown in the FIG., an individual may access options such as “Home,” “Products,” “Training,” “Nutrition,” “Partners,” “Science,” and “About Us.” In this example, Nutrition option 304 has been selected by the individual.

Introductory display screen 300 may include an option map 306. Option map 306 may provide a user with a list of possible options to access within nutrition option 304. For example, as shown in the FIG., a user may access options such as “Overview,” “Macro-nutrients,” “Micro-nutrients,” “Meal Plans,” “Recipes,” and “Custom Solution.” In this example, Custom Solution option 308 has been selected by the individual, as indicated by the boldfaced type.

As described hereinabove, an individual may be provided with a questionnaire in connection with designing and delivering a nutritional supplement regime in accordance with the present invention. Custom Solution option 308 allows a user to proceed through a questionnaire in steps, as shown in menu region 310. As shown, there are six steps for the user to complete in connection with the questionnaire: Step 1 “Introduction” (option 312), Step 2 “Personal Information” (option 314), Step 3 “Nutritional Habits” (option 316), Step 4 “Exercise Habits” (option 318), Step 5 “Health Information” (option 320), and Step 6 “Personal Goals” (option 322). These steps are merely illustrative. An individual may be provided with any suitable steps in connection with obtaining information from the individual for use in designing and delivering a nutritional supplement regime. Furthermore, some or all of the steps shown in menu region 310 may be performed.

As shown in the FIG., Step 1 Introduction (option 312) has been selected by the individual, as evidenced by the boldfaced type. Introductory information region 324 may provide the user with an introduction to the questionnaire.

Introductory display screen 300 may include Begin option 326. In response to a user selecting Begin option 326, the nutritional supplement questionnaire application may provide a display screen in connection with Step 2 Personal Information.

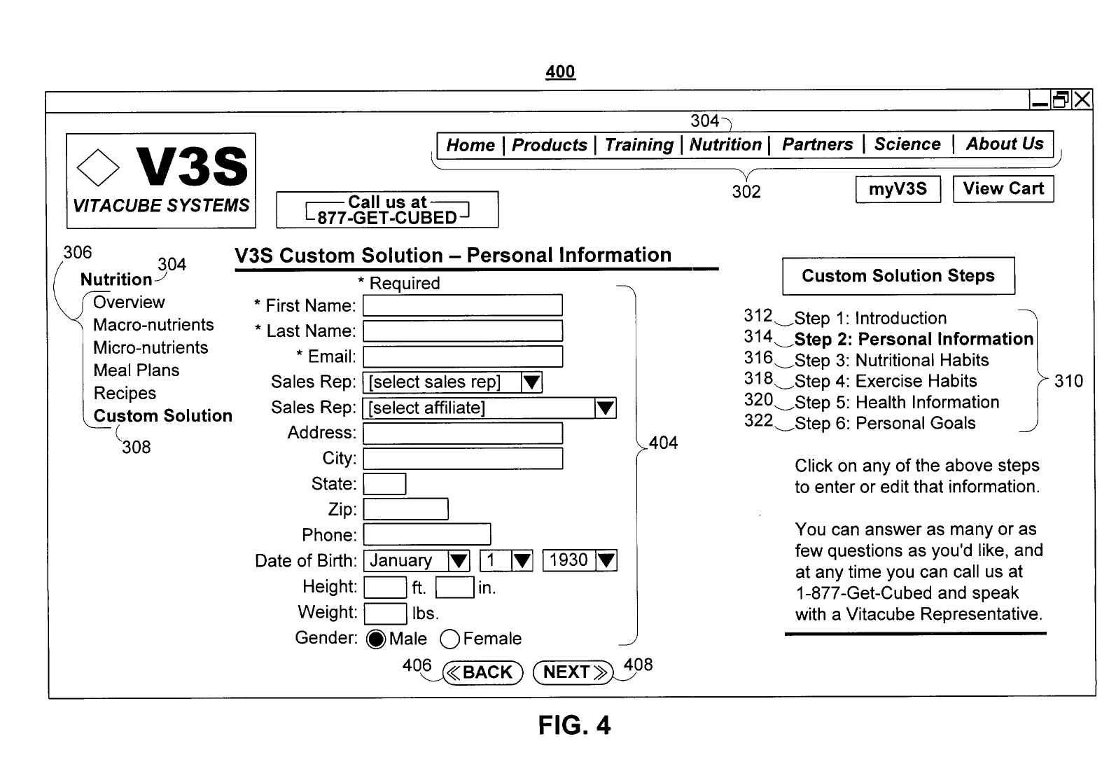

FIG. 4 shows an illustrative personal information display screen 400 that may be provided to the individual by the nutritional supplement questionnaire application in accordance with the present invention.

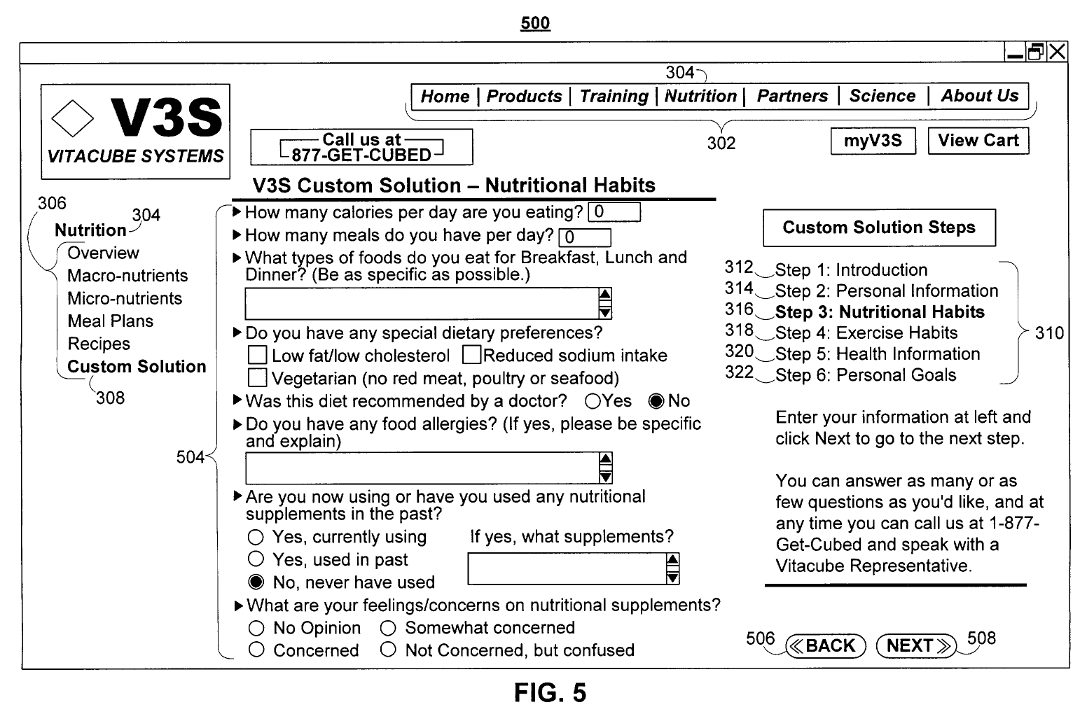

Personal information display screen 400 of FIG. 4 has display characteristics and features similar to those of introductory display screen 300 of FIG. 3. For example, personal information display screen 400 also includes menu region 302, option map 306, and menu region 310. In one example, the nutritional supplement questionnaire application may provide personal information display screen 400 in response to an individual's selection of Begin option 326 of introductory display screen 300 (FIG. 3). In another example, the nutritional supplement questionnaire application may provide personal information display screen 400 in response to an individual's selection of Step 2 Personal Information (option 314) of menu region 310. In yet another example, the nutritional supplement questionnaire application may provide personal information display screen 400 in response to an individual's selection of Back option 506 of nutritional habits display screen 500 (FIG. 5).

As shown in FIG. 4, personal information display screen may include an information entry region 404. Information entry region 404 may include fields where the individual may input information such as, for example, name, e-mail, sales representative, home address, phone number, date of birth, height, weight, gender, or any other suitable personal information. The individual may input the information into information region 404 using, for example, input device 210 of FIG. 2. The individual may be required to input information into certain fields prior to gaining access to other display screens. For example, the individual may be required to enter his or her name and e-mail address prior to gaining access to nutritional habits display screen 500 (FIG. 5).

Personal information display screen 400 may include Back option 406. In response to an individual's selection of Back option 406, the nutritional supplement questionnaire application may provide the previous display screen, introductory display screen 300 (FIG. 3). Personal information display screen 400 may also include Next option 408. In response to an individual selecting Next option 408, the nutritional supplement questionnaire application may provide a display screen in connection with Step 3 Nutritional Habits.

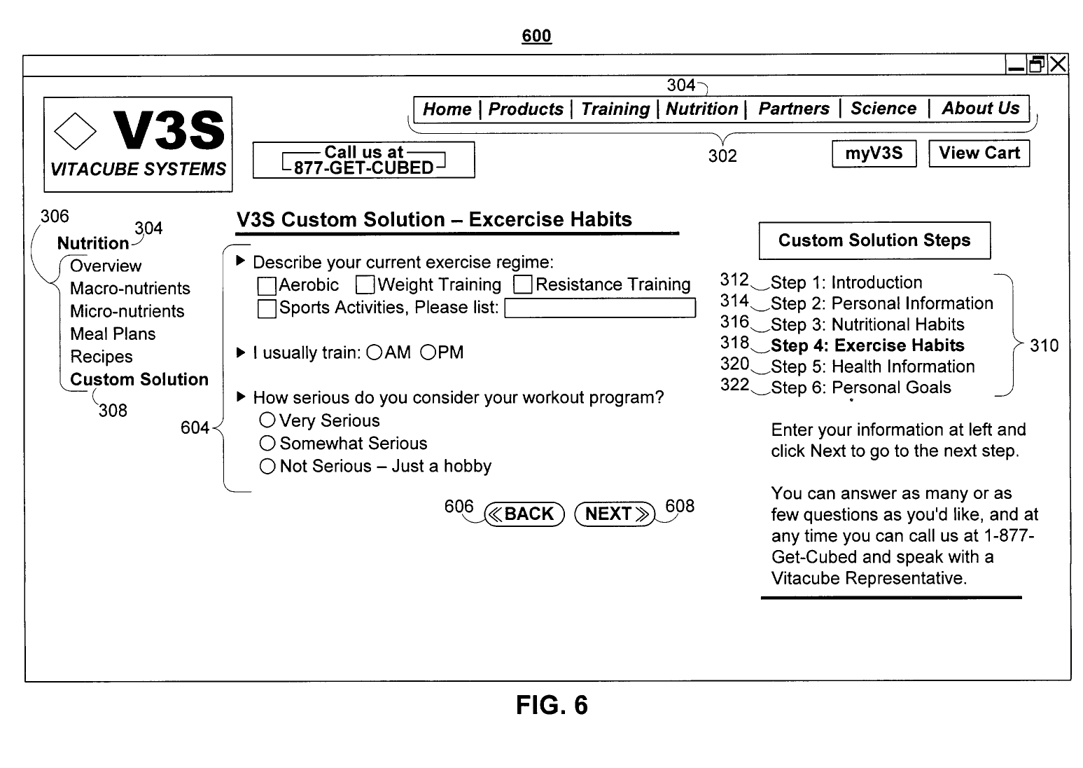

Nutritional Habits display screen 500 of FIG. 5 has display characteristics and features similar to those of the previous screens. In one example, the nutritional supplement questionnaire application may provide nutritional habits display screen 500 in response to an individual's selection of Next option 408 of personal information display screen 400 (FIG. 4), as described hereinabove. In another example, the nutritional supplement questionnaire application may provide nutritional habits display screen 500 in response to an individual's selection of Step 3 Nutritional Habits (option 316) of menu region 310. In yet another example, the nutritional supplement questionnaire application may provide nutritional habits display screen 500 in response to an individual's selection of Back option 606 of exercise habits display screen 600 (FIG. 6).

As shown in FIG. 5, nutritional habits display screen 500 may include an information entry region 504. Information entry region 504 may include fields where the individual may input information such as, for example, calories consumed per day, meals per day, types of foods consumed, dietary preferences, food allergies, past nutritional supplement usage, concerns, or any other suitable information related to an individual's nutritional habits. The individual may input the information into information region 504 using, for example, input device 210 of FIG. 2.

Nutritional habits display screen 500 may include Next option 508. In response to an individual selecting Next option 508, the nutritional supplement questionnaire application may provide a display screen in connection with Step 4 Exercise Habits.

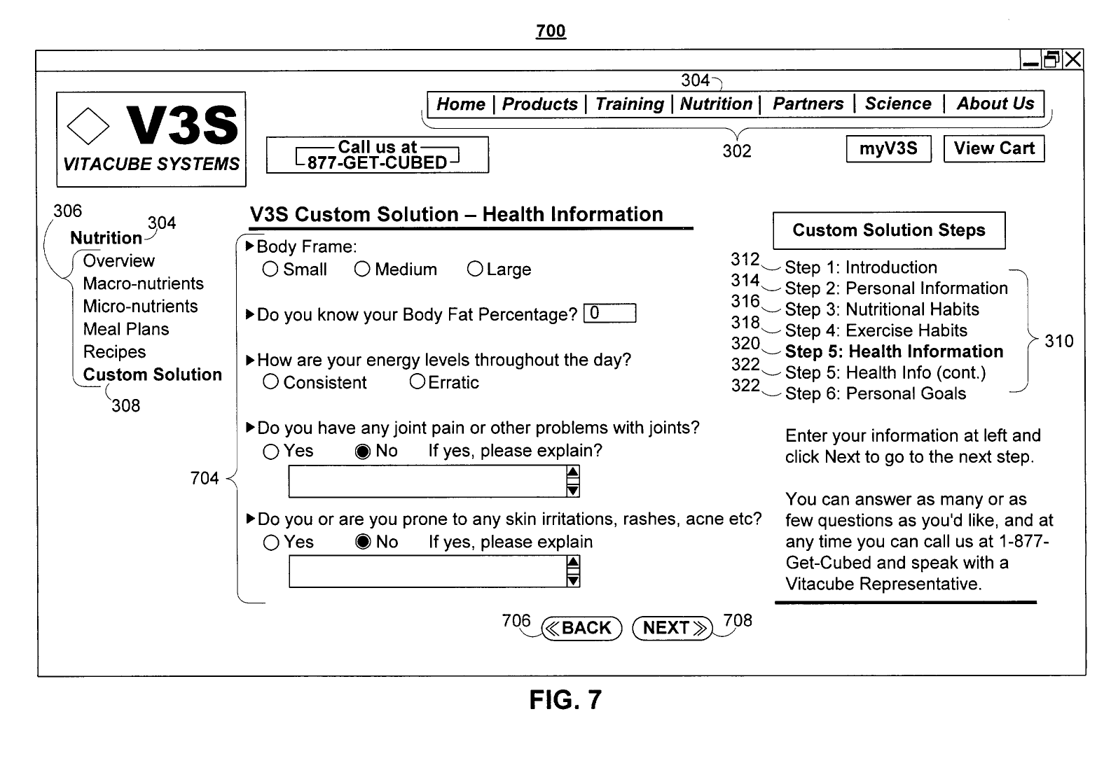

Exercise Habits display screen 600 of FIG. 6 has display characteristics and features similar to those of the previous screens. In one example, the nutritional supplement questionnaire application may provide exercise habits display screen 600 in response to an individual's selection of Next option 508 of nutritional habits display screen 500 (FIG. 5), as described hereinabove. In another example, the nutritional supplement questionnaire application may provide exercise habits display screen 600 in response to an individual's selection of Step 4 Exercise Habits (option 318) of menu region 310. In yet another example, the nutritional supplement questionnaire application may provide exercise habits display screen 600 in response to an individual's selection of Back option 706 of health information display screen 700 (FIG. 7).

As shown in FIG. 6, exercise habits display screen 600 may include an information entry region 604. Information entry region 604 may include fields where the individual may input information such as, for example, current exercise regimen, training preferences, level of discipline, or any other suitable information related to an individual's exercise habits. The individual may input the information into information region 604 using, for example, input device 210 of FIG. 2.

Exercise habits display screen 600 may include Next option 608. In response to an individual selecting Next option 608, the nutritional supplement questionnaire application may provide a display screen in connection with Step 5 Health Information.

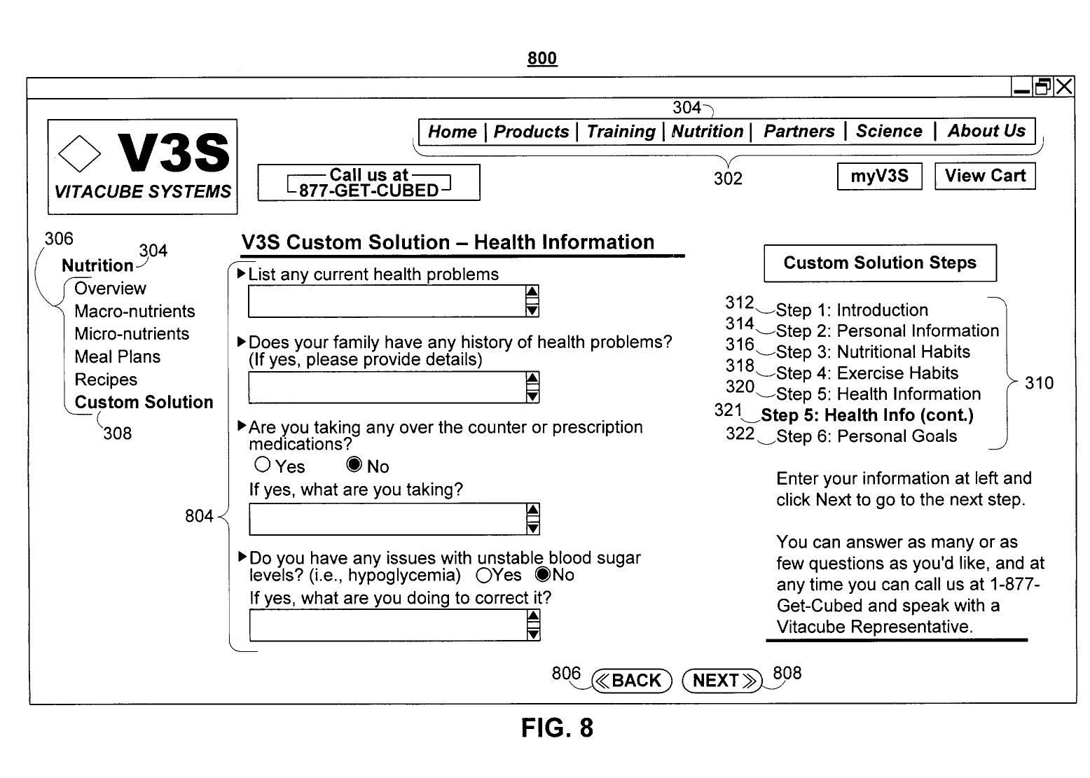

Health information display screen 700 of FIG. 7 has display characteristics and features similar to those of the previous screens. In one example, the nutritional supplement questionnaire application may provide health information display screen 700 in response to an individual's selection of Next option 608 of exercise habits display screen 600 (FIG. 6), as described hereinabove. In another example, the nutritional supplement questionnaire application may provide health information display screen 700 in response to an individual's selection of Step 4 Health Information (option 320) of menu region 310. In yet another example, the nutritional supplement questionnaire application may provide health information display screen 700 in response to an individual's selection of Back option 806 of health information display screen 800 (FIG. 8).

As shown in FIG. 7, health information display screen 700 may include an information entry region 704. Information entry region 704 may include fields where the individual may input information such as, for example, body frame, body fat percentage, energy levels, joint problems, skin irritations, or any other suitable information related to an individual's health. The individual may input the information into information region 704 using, for example, input device 210 of FIG. 2.

Heath information display screen 700 may include Next option 708. In response to an individual selecting Next option 708, the nutritional supplement application may provide another display screen in connection with Step 5 Health Information.

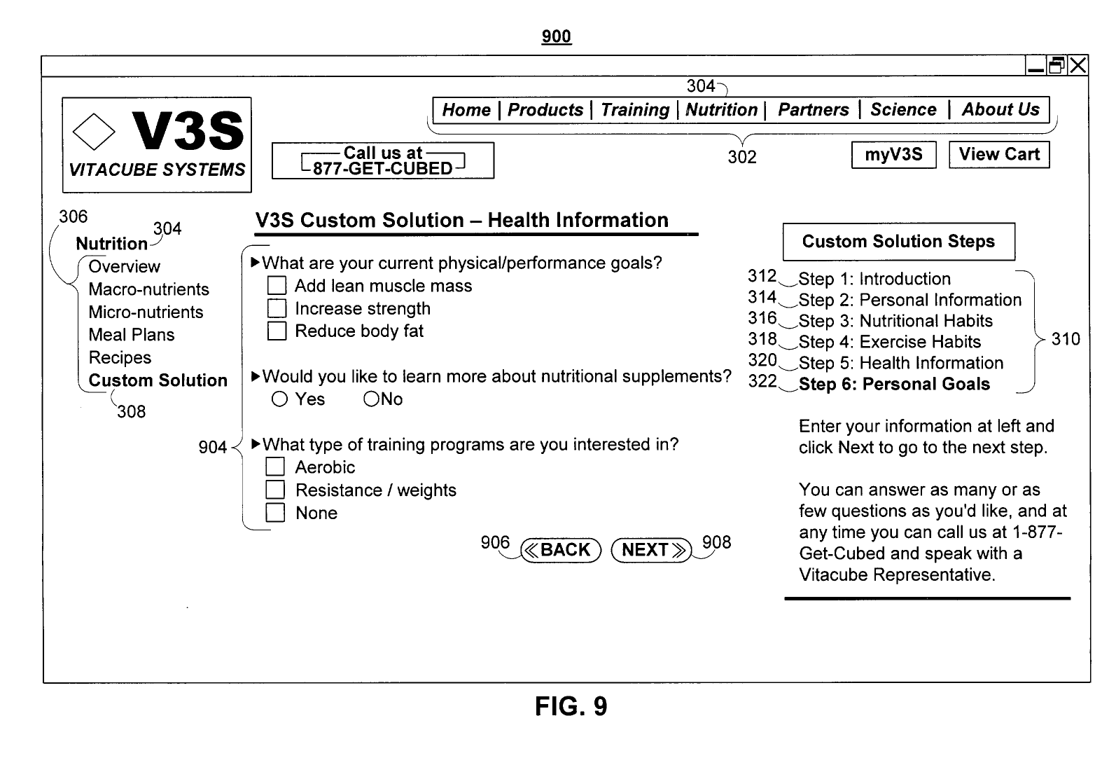

Health information display screen 800 of FIG. 8 has display characteristics and features similar to those of the previous screens. In one example, the nutritional supplement questionnaire application may provide health information display screen 800 in response to an individual's selection of Next option 708 of health information display screen 700 (FIG. 7), as described hereinabove. In another example, the nutritional supplement questionnaire application may provide health information display screen 800 in response to an individual's selection of Step 5 “Health Information (cont.)” (option 321) of menu region 310. In yet another example, the nutritional supplement questionnaire application may provide health information display screen 800 in response to an individual's selection of Back option 906 of personal goals display screen 900 (FIG. 9).

As shown in FIG. 8, health information display screen 800 may include an information entry region 804. Information entry region 804 may include fields where the individual may input information such as, for example, current health problems, family health history, current medications, blood sugar levels, or any other suitable information related to an individual's health. The individual may input the information into information region 804 using, for example, input device 210 of FIG. 2.

Health information display screen 800 may include Next option 808. In response to an individual selecting Next option 808, the nutritional supplement questionnaire application may provide a display screen in connection with Step 6 Personal Goals.

Personal goals display screen 900 of FIG. 9 has display characteristics and features similar to those of the previous screens. In one example, the nutritional supplement questionnaire application may provide personal goals display screen 900 in response to an individual's selection of Next option 808 of health information display screen 800 (FIG. 8), as described hereinabove. In another example, the nutritional supplement questionnaire application may provide personal goals display screen 900 in response to an individual's selection of Step 6 Personal Goals (option 322) of menu region 310.

As shown in FIG. 9, personal goals display screen 900 may include an information entry region 904. Information entry region 904 may include fields where the individual may input information such as, for example, current physical or performance goals, interest in nutritional supplements, interest in training programs, or any other suitable information related to an individual's personal goals. The individual may input the information into information region 904 using, for example, input device 210 of FIG. 2.

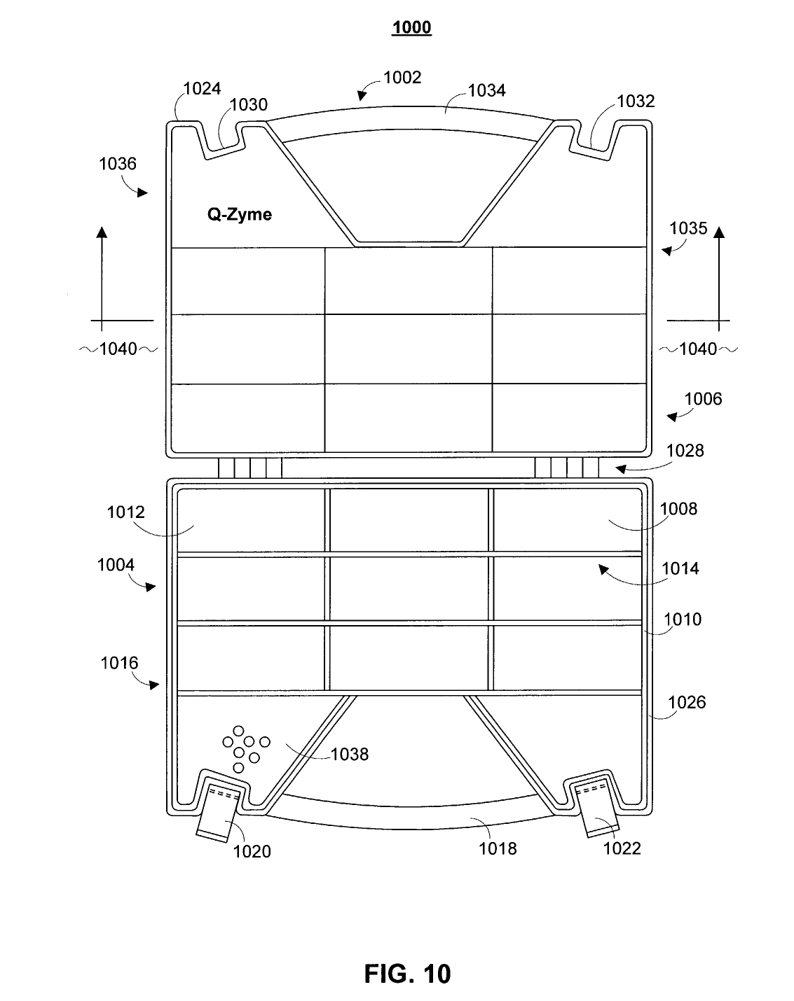

As described hereinabove, nutritional supplements may be assembled into a “kit” for delivery to an individual. An illustrative kit is described in, for example, co-pending and commonly-assigned U.S. patent application Ser. No. 09/704,429, filed Nov. 1, 2000, which is hereby incorporated by reference herein in its entirety. An illustrative kit in accordance with the present invention is shown in FIGS. 10-14.

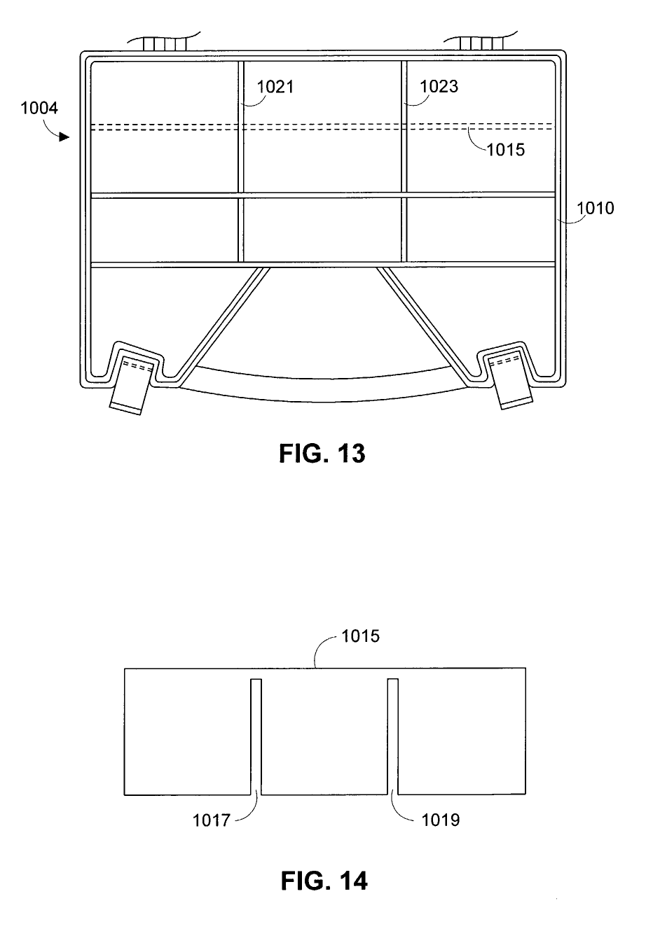

FIG. 10 shows illustrative kit 1000 in accordance with this invention. Kit 1000 may include a case 1002 having a compartment 1004 and a cover 1006 which mates with compartment 1004. Case 1002 may be constructed from a rigid material such as, for example, plastic (e.g., polyethylene (“PE”), polyethylene terephthalate (“PET”), polypropylene (“PP”), polystyrene (“PS”), polycarbonate (“PC”)), cardboard, metal (e.g., steel, aluminum) or any other suitable rigid material. Compartment 1004 may be a shallow “vessel” having a bottom 1008 and a wall portion 1010. A recess 1012 is formed by bottom 1008 and wall portion 1010 of compartment 1004. Compartment 1004 includes a handle portion 1018 and a pair of rotatable latches 1020 and 1022. A plurality of partitions 1014 are placed within recess 1012 according to a predetermined pattern. As shown in FIG. 10, partitions 1014 form a plurality of open chambers 1016, each of which is capable of holding a nutritional supplement. Partitions 1014 may be, for example, permanently arranged within recess 1012. In another example, partitions 1014 may be removably fixed within recess 1012, which is shown in more detail in FIGS. 13 and 14.

As shown FIGS. 13 and 14, partitions 1014 may be removably fixed within recess 1012. For example, a partition 1015 may be removed from compartment 1004. The previous location of partition 1015 is represented in FIG. 13 by a dotted line. Partition 1015 may include slots 1017 and 1019 (FIG. 14) that interact with partitions 1021 and 1023, respectively. For example, partitions 1021 and 1023 may be received removably within slots 1017 and 1019, respectively. In one example, partition 1015 may also interact with slots (not shown) in wall portion 1010, such that partition 1015 slides into and out of the slots in the wall portion for insertion and removal, respectively. The interaction of a partition such as partition 1015 with slots in a wall portion of a case, such as case 1002, is conventionally known to one of skill in the art. In another example, wall portion 1010 may be constructed without slots.

Referring back to FIG. 10, it should be noted that the arrangement of partitions 1014 may vary according to the number and types of nutritional supplements included in kit 1000. As described hereinbelow, a multitude of nutritional supplements for various purposes are available for inclusion in kit 1000.

Case 1002 includes a cover 1006 which is matable with compartment 1004 through an edge portion 1024 which rests on shelf 1026 of compartment 1004. Hinges 1028 connect to compartment 1004 and cover 1006 and permit the rotation of these elements with respect to one another (see, for example, FIG. 12). Cover 1006 includes latch receivers 1030 and 1032 which interact with rotatable latches 1020 and 1022, respectively, in a conventional manner. Handle portion 1034 lies adjacent handle portion 1018 of compartment 1004 when case 1002 is closed, thereby permitting the case to be carried by an individual.

Case 1002 includes a placard 1035, which includes a pattern that mimics the plurality of chambers 1016 of compartment 1004. Placard 1035 includes indicia 1036 (e.g., “Q-Zyme”) that identifies and locates a particular nutritional supplement, such as nutritional supplement 1038 (e.g., tablets of QZyme™). Although the example of FIG. 10 shows only one nutritional supplement, this is merely for simplification. Some or all of chambers 1016 may contain a nutritional supplement, and it follows that placard 1035 may include indicia corresponding to those nutritional supplements included in case 1002.

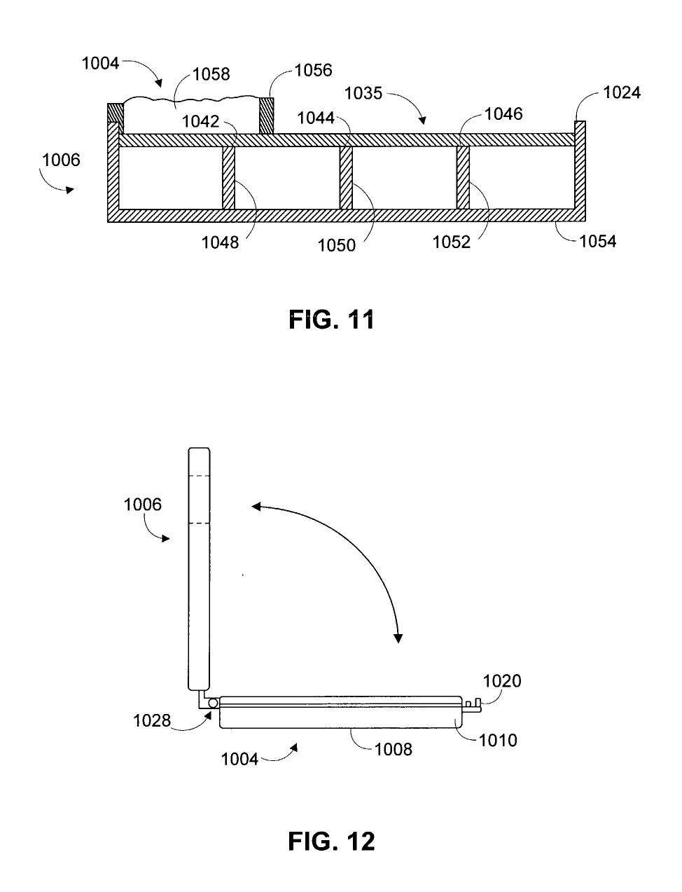

Referring to FIG. 11, which is a sectional view of case 1002 taken through line 1040-1040, placard 1035 rests atop surfaces 1042, 1044, and 1046 of supports 1048, 1050, and 1052, respectively. Surfaces 1042, 1044, and 1046 lie opposite bottom surface 1054 of cover 1006. Bottom surface 1054 forms an outer surface of case 1002 when cover 1006 mates with compartment 1004. As shown in the FIG., partition 1056 of compartment 1004 forms chamber 1058 within compartment 1004. Placard 1035 seals or closes chamber 1058 when cover 1006 mates with compartment 1004. Such sealing of the plurality of open chambers 1016, as shown in FIG. 10, occurs in the same manner as the sealing of chamber 1058, as described hereinabove.

Plurality of open chambers 1016 are formed by the placement of partitions 1014 within recess 1012 of compartment 1004. Nutritional supplements such as nutritional supplement 1038 are placed in the plurality of open chambers 1016. Placard 1035 is mounted within cover 1006 to designate and locate a particular nutritional supplement based on the indicia 1036 found on placard 1035 (e.g., Q-Zyme). Cover 1006 is then mated with compartment 1004 and latched, using latches 1020 and 1022 with latch receivers 1030 and 1032, respectively. Handle portions 1018 and 1034 are also assembled to permit case 1002 to be carried. The individual may then open case 1002, locate the particular nutritional supplement to be used by indicia 1036 on placard 1035, and remove the nutritional supplement for ingestion. Following retrieval of a particular nutritional supplement or supplements, the individual may then mate cover 1006 with compartment 1004 until further nutritional supplements are needed.

Described hereinbelow are various nutritional supplements or “modules” available for incorporation into the systems and methods of the present invention. The nutritional supplements described hereinbelow are merely examples and are not intended to limit the systems and methods of the present invention. Further, the names assigned to the nutritional supplements are merely for illustrative purposes. As one of skill in the art will appreciate, these nutritional supplements may be manipulated in many ways to provide customized “kits” of nutritional supplements for individuals. The nutritional supplements described hereinbelow, therefore, may be interchanged, rearranged, or subdivided in accordance with the present invention. It should be noted that the statements made hereinbelow in connection with the nutritional supplements have not been evaluated by the Food and Drug Administration (“FDA”), and that the nutritional supplements are not intended to diagnose, treat, cure, or prevent any disease.

Absorbit™ is a blend of five photo-enzymes, including the plant-derived enzyme system called Aminogen®. Plant enzymes are used because of the decreased incidence of allergic reactions that an individual may have when taking digestive enzymes. Plant enzymes allow a human body to absorb vital nutrients from foods by properly breaking down proteins, fibers, carbohydrates, and fats. As an individual ages, these digestive enzymes are secreted less, which can cause discomfort and intolerances in the individual. Thus, this blend of enzymes focuses on these specific elements and supports digestive health.

As described hereinabove, the body may have a difficult time digesting and breaking down proteins, fibers, carbohydrates, and fats. One reason for the difficulty is because of the intense and somewhat complex structures of proteins, fibers, carbohydrates, and fats. To alleviate this difficulty, Absorbit™ includes amylase, for digestion of carbohydrates; cellulase, for digestion of fibers; lipase, for digestion of fats; and lactase, for digestion of lactose (i.e., milk sugar). Lactase is included in Absorbit™ because approximately 25% of individuals suffer from lactose intolerance, a condition in which the body is unable to break down and digest the valuable sugars in dairy products. Lactase relieves the gas, bloating, and diarrhea that are common symptoms of lactose intolerance.

Aminogen® is included in Absorbit™ because of its enhancing effects on protein absorption. Aminogen® is a plant-derived enzyme system that breaks down proteins into free-form amino acids, making the protein more available to muscles and cells. Aminogen® has been shown to increase amino acid absorption by at least 200%, optimizing the protein in the foods and supplements that individuals ingest.

AlphaNac™ includes alpha lipoic acid and N-Acetyl-Cystenine, two elements that are paramount to liver detoxification and cellular metabolism. Alpha lipoic acid and N-Acetyl-Cystenine are combined to make an efficient and methodical detoxifier of dangerous free radicals that are created when the body is under stress.

When individuals put their bodies through stress, with causes ranging from exercise to inhaling pollutants, free radicals are produced in the body. These free radicals, if left active, may damage cell walls and may even damage deoxyribonucleic acid (“DNA”). The liver needs assistance in diffusing these free radicals and filtering them from the body. Alpha lipoic acid is a powerful anti-oxidant, neutralizing free radicals before they cause damage. N-Acetyl-Cystenine helps the liver transport these neutralized free radicals out of the system, which may eliminate the radicals permanently. The combination of a neutralizer (e.g., alpha lipoic acid) and transporter (e.g., N-Acetyl-Cystenine) ensures better health and function for an individual's liver.

AO Elite™, which includes L-Arginine and L-Ornithine, helps to increase circulation and build muscle within the body. High grades of L-Arginine and L-Ornithine are used in AO Elite™, thereby resulting in easy absorption of AO Elite™ in the intestinal walls.

L-Arginine has been shown to raise levels of nitrogen oxide, which thereby increases blood circulation in the body without raising blood pressure. In addition, L-Arginine reduces the tendency for blood platelets to stick together, thereby reducing the incidence of blood clots that can result in heart attacks and strokes. L-Ornithine, being a valuable branched chain amino acid, is vital in building muscle in the body. When combined with L-Arginine, L-Ornithine plays a vital role in the metabolism of excess fat by releasing growth hormones.

Cal/Mag+™ contains calcium, magnesium, and boron, which are three minerals needed for healthy bones and strong muscles. Calcium is the most abundant mineral in our body, but many individuals receive only half of the calcium they actually need. There are seven different sources of calcium in Cal/Mag+™, allowing for a heightened release of calcium over a longer duration of time. This gives the body ample opportunity to absorb this essential mineral. Various forms of calcium absorb into the body at different rates. For example, some forms of calcium are slow to absorb into the body, while other forms of calcium may be quicker to absorb into the body. Combining seven different sources of calcium, all with varying rates of absorption, allows the body to make sure that it receives the calcium that it needs at the appropriate times. In addition to making sure that the body has the types and quantities of calcium that are beneficial, the calcium included in Cal/Mag+™ is lead-free, thereby reducing any toxic effects.

The bones need magnesium as much as calcium, and Cal/Mag+™ has four different sources of magnesium. Magnesium is vital for bone strength, but magnesium cannot be absorbed by the intestinal wall without calcium as a transporter. Therefore, Cal/Mag+™ includes both calcium and magnesium, making efficient magnesium transport and use, and thereby resulting in stronger, healthier bones.

Cal/Mag+™ also includes boron to strengthen the fibers within bone and to assist in the production of natural steroid compounds within the body.

Complex SPP™ may decrease the size of an enlarged prostate and may reduce the likelihood of prostate cancer in men, specifically, in men over the age of forty. Cancer of the prostate gland is the second leading cause of cancer death among men. A purified form of saw palmetto berry extract, which contains 85% fatty acids and sterols, is the potent ingredient in Complex SPP™ that combats the effects of prostate enlargement. Purified forms of saw palmetto berries are kept active, for example, by placing extract in gel capsules.

Along with the saw palmetto berry extract, Complex SPP™ also contains pumpkin seed oil, pygeum, and selenium. Pumpkin seed oil is a valuable antioxidant that reduces bladder and urethral pressure, which are common symptoms of an enlarged prostate. Pygeum has been shown to reduce inflammation in prostate tissue, while selenium works to maintain normal prostate function.

CP Complex™ includes vitamin C and potassium, thereby capitalizing on the benefits of their combination. Vitamin C, also known as ascorbic acid, is required for at least 300 metabolic functions in the body. Potassium, a mineral responsible for regulating heartbeat and blood pressure, works best in acidic environments.

Vitamin C supplementation is essential because the body does not have the ability to manufacture this vitamin. Because vitamin C is crucial to cellular metabolism, CP Complex™ contains the highest grades of various types of vitamin C. Different types of cells in the body react to different forms of vitamin C. Thus, CP Complex™ uses four different forms of vitamin C to ensure maximum uptake and utilization of the vitamin C by the body. Vitamin C serves the body as a primary antioxidant and helps to support immune system function.

After calcium and phosphorus, potassium is the most abundant mineral in the body. Potassium, an electrolyte, is vital along with sodium in keeping balanced fluid levels in the body. Three different sources of potassium are used to maintain a stable release of this electrolyte so that maximum benefits may be achieved.

GC Elite™ contains L-Glutamine and L-Carnitine, and is useful for both individuals who are working to build muscle (e.g., athletes) and individuals who desire to burn excess fat.

The most abundant free form amino acid found in the muscles is L-Glutamine. Muscles need L-Glutamine to synthesize muscle protein that is necessary for repair and recovery. L-Glutamine is useful not only in building muscle, but also in preventing the “wasting” of muscle that is often associated with bed rest or sickness. In times of stress and injury, glutamine can be sucked into the bloodstream away from the muscles. However, with proper supplementation, this can be prevented.

The main function of L-Carnitine is to help utilize the fatty acids that are found in cells so that the body can use the fatty acids as energy. L-Carnitine can provide the major source of energy to an individual when his or her body needs it the most. By increasing the use of fatty acids as an energy source, an individual may decrease the amount of fatty acid build-up in the heart, liver, and muscles.

GC Elite™ works together with the body to reduce excess body fat or to use the fat present as a prominent energy source.

JSH™ includes glucosamine, chrondroitin, methyl sulfonyl methane (“MSM”), and natural anti-inflammatories. Approximately sixteen-million of the U.S. population live with joint pain and stiffness. JSH™ was created to help ease joint pain and stiffness by getting to the root of the problem. Glucosamine and chrondroitin, combined with MSM and natural anti-inflammatory agents, are the main components of JSH™ that may help to slow down the degeneration of aging cartilage and to regenerate and repair aging cartilage.

In over 300 studies and twenty clinical trials, glucosamine has shown to build and repair cartilage. Glucosamine, a fairly small molecule, combines with the larger molecules that are necessary for cartilage repair and maintenance. Glucosamine works as an amino sugar, a component of carbohydrates that make up body tissue, and therefore is involved in the formation of nails, tendons, skin, eyes, bones, ligaments, and heart valves. Glucosamine can provide significant relief from pain and inflammation in individuals affected with arthritis and osteoarthritis.

Glucosamine, when combined with chrondroitin, which is another carbohydrate molecule, has even greater results in the regeneration of cartilage tissue. Chrondroitin attaches to protein molecules that attract water to cartilage tissue, which is vital for maintaining healthy joint cartilage. By blocking certain enzymes that prevent nutrients from being transported to cartilage, chrondroitin also helps stop premature degeneration of existing cartilage.

Individuals who suffer from arthritis often have inflammation around the joints. Natural herbs such as cayenne, boswellia, and turmeric are included in JSH™ to provide safe anti-inflammatory agents without prescription drug-like side effects. MSM is a high-grade source of sulfur, which is necessary for ligaments and tendons to be strong and healthy.

M32+™ includes chromium, zinc, B-complex vitamins, and folic acid. Two M32+™ tablets may be taken daily to provide sufficient nutrients for the body to function at optimal performance. M₃₂+™ does not include fillers or incipients, but rather includes only highly concentrated and high quality ingredients.

Q-Zyme™ includes coenzyme Q₁₀ to provide an antioxidant and an energy metabolizer. Coenzyme Q₁₀ is the primary component of Q-Zyme™.

Without sufficient quantities of coenzyme Q₁₀, the body may develop cardiovascular disease. Coenzyme Q₁₀ is responsible for being a catalyst in cellular metabolism, breaking food into “packets” of energy. Acting with other enzymes, coenzyme Q₁₀ provides energy to cells so that the cells can digest foods, heal wounds, and maintain healthy muscles. The energy provided by coenzyme Q₁₀ and other enzymes is also used in circulating blood throughout the body, insuring proper heart function.

In addition to being the primary catalyst for energy production, coenzyme Q₁₀ is one of the most powerful anti-oxidants in the body. Much like vitamin C and vitamin E, coenzyme Q₁₀ helps the body neutralize dangerous free radicals that can damage cell walls and DNA.

Ultra EFA+E™ includes essential fatty acids (“EFAs”) Omega 3, Omega 6, and Omega 9, and also includes a natural source of vitamin E. Fats are essential for proper health and cellular function. EFAs are fats that are necessary for proper health, yet the body is unable to produce these fats

Fatty acids are the building blocks of fats and oils. The differences between Omega 3, Omega 6, and Omega 9 are mainly structural differences. These EFAs are often derived from fish oils. In the present invention, these EFAs include not only marine lipids (e.g., fish oils), but also vegetable-based oils such as flaxseed oil, evening primrose oil, sunflower oil, and rice oil. These vegetable-based oils are rich in EFAs, yet lack the “fishy” after-test that is common with taking other fatty acid supplements. Preserving the EFAs in their most active form-oil—and having a soft gel cover, Ultra EFA+E™ tablets maximize the benefits for skin, hair, blood pressure, arthritis prevention, and reduction of harmful blood clots.

Vitamin E is not only valuable as an antioxidant to the brain, but it also allows the active fatty oils in Ultra EFA+E™ to remain preserved. Without a preservative such as vitamin E, the EFAs would become rancid over time and create dangerous free radicals. Using a natural preservative such as vitamin E not only assures longer, purer shelf-life, but also adds an important antioxidant for the brain. Without EFAs and vitamin E, as included in Ultra EFA+E™, nerve impulses that are needed for normal development of the brain may not be transmitted.

WNB™ may be used daily by women to regulate normal hormonal levels in the body. WNB™ includes don quai (often called “women's herb” by the ancient Chinese and Japanese), isoflavons, vitamin B₆, calcium, and other ingredients.

Don quai is a popular herbal supplement in China and Japan, and it is second in popularity only to ginseng. Don quai is traditionally used, for example, to balance the menstrual cycle, correct abnormal bleeding patterns, alleviate symptoms of premenstrual syndrome (“PMS”), and reduce menopausal hot flashes. Don quai is thought to have estrogens that can minimize the negative effects of a woman's own estrogens. WNB™ was developed to be a balance, and therefore don quai is included along with the other ingredients listed hereinabove to create this balance.

Vitamin B₆, isoflavons, calcium, and various herbs are included in WNB™ to help regulate hormonal levels. The combination of ingredients allows WNB™ to determine what hormonal levels are unbalanced and use the precise ingredient or ingredients necessary to create stabilization. Keeping hormonal levels from fluctuating may reduce the number of mood swings and the occurrence of menstrual difficulties for a woman, and may further preserve overall better health.

ZMA Pro™ includes micronutrients, an activating system (e.g., the VitaCube Activating System™), and various herbs to provide a safe alternative to increasing testosterone production.

Trace elements zinc and magnesium are important for a multitude of biological functions. Deficiencies in these nutrients may lead to a lack of testosterone production, immune system malfunction, and stunted muscular growth. Zinc and magnesium in combination are vital to the enhancement of muscle growth and performance.

The activating system and the various herbs help ZMA Pro™ to be effectively absorbed into the gastrointestinal wall. Epimedium sagittatum, potassium, glycerol phosphate, and cayenne are just some of the elements that help to accelerate the absorption of ZMA Pro™ and increase its use in the cells. Using epimedium sagittatum, potassium, glycerol phosphate, and cayenne along with the most stable, easily-absorbed chelated minerals makes ZMA Pro™ the natural alternative to healthy hormone production.

Balanced Mood™ is directed towards treating mild depression. From depression, other conditions such as anxiety, stress, fibromyalgia, and chronic pain may develop. Balanced Mood™ is a nutritional supplement that allows the mind to become more focused, relaxed, and level. Balanced Mood™ is a natural alternative to pharmaceuticals without dangerous side effects. St. John's wort, chamomile flowers, griffonia extract, and other herbs are used as alternatives to prescription medicine for fighting depression and bringing an individual back to positive mental health.

St. John's wort has been celebrated for years because of its effects on treating mild depression. St. John's wort has been shown to increase levels of serotonin, which plays a major role in the brain's improvement of moods and emotions. St. John's wort also promotes sound sleep, which is valuable because depression is often marked by fatigue, sleepiness, and low energy levels.

Chamomile is included in Balanced Mood™ to provide calmness and reduce anxiety in an individual. Chamomile has been shown to contain substances that act on the same parts of the brain and nervous system that anti-anxiety drugs effect. Acting in these various areas of the brain and nervous system allows the body to relax. Chamomile naturally relaxes the body and creates a balance when dealing with erratic emotions in an individual.

Griffonia extract and a combination of other various herbs work on the body as anti-oxidants and enhance activity of neurological transmission. Due to physical and environmental stresses, free radicals may be produced in the body that affect the way an individual feels and thinks. These powerful antioxidants help to neutralize the free radicals and promote mental well-being.

A combination of St. John's wort and various herbs allows Balanced Mood™ to regulate an individual's emotions. Depression may cause a multitude of other symptoms that are not only harmful to the physical body, but also harmful to the mental mind. Balanced Mood™ is designed to lessen these symptoms and nurture the mind and body back to health.

Enduro Max™ creates a balance between various ginsengs and nutrients to maximize the benefits of high energy and promote sustained endurance in an individual. Athletes have been trying for years to improve their athletic performance by increasing their endurance and stamina. Often, athletes push the body to optimal levels, which can be dangerous. Furthermore, the substances that may allow an individual to exceed his or her capabilities are deadly.

Ginseng has been used as a general tonic to combat weakness and provide extra energy. Instead of using one type of ginseng for Enduro Max™, this nutritional supplement combines a group of “hot/cold” or “red/white” ginsengs. Every ginseng has a variety of benefits, such as increasing energy levels higher or increasing stamina longer. Combining six different types of ginseng allows Enduro Max™ to provide not just a burst of quick energy but rather a constant supply of energy over a longer duration of time. In addition, since various body types and activity levels require different forms of energy, Enduro Max™ covers all of these bases by including six different types of ginseng.

Compared to carbohydrates, proteins, or sugars, the body stores the most energy in fats. Ginseng has been shown to prevent fatigue by sparing glycogen, commonly used for energy, and instead using the optimal energy source in fatty acids. Using fatty acids as the primary source for energy enhances athletic performance, rejuvenates the body more quickly, increases longevity, and helps to detoxify and normalize the entire system.

Combining ginseng with riboflavin and vitamin B12 allows Enduro Max™ to enhance both its utilization of energy stores and metabolic function. Both riboflavin and vitamin B12 help to supply energy by promoting, manufacturing, and transporting oxygen-containing red blood cells to all the cells in the body.

Ginkgo Clear™ provides the brain with valuable elements that are needed for enhanced clarity and mental well-being. Often the mind is called upon to provide concentration and focus. Clearing the mind is important in these situations, and therefore supplying the mind with the proper energy to do so is vital.

Ginkgo biloba, a Chinese herb, has survived in China for over 200-million years. Ginkgo Clear™ includes a standardized, concentrated form of ginkgo biloba extract to activate the nutritional supplement. Ginkgo biloba has been shown to increase blood flow to the brain by regulating the tone and elasticity of blood vessels. In addition, ginkgo biloba helps to reduce the “stickiness” of the blood, thereby lowering the risk of blood clots and improving circulatory flow. Acting as an antioxidant, or free radical scavenger, ginkgo biloba aids in the maintenance of healthy blood cells.

Improving mental clarity also starts with protecting the brain from dangerous free radicals that cause oxidation. Ginkgo Clear™ includes vitamin E, which protects the brain from free radical oxidation. The basic function of vitamin E is to protect cell membranes, making vitamin E a powerful antioxidant in the body. One of the most important membranes in the body is the membrane between the brain and flowing blood, also known as the blood-brain barrier. Neutralizing free radicals before they destroy the blood-brain barrier safeguards the brain from further destruction and deterioration.

Ginkgo Clear™ provides mental well-being by first protecting the brain from dangerous, toxic elements as described hereinabove, and then by supplying the brain with nutrients to support its proper health and development.

“MultiChews” are pleasant tasting, chewable multi-vitamins/minerals that provides the body with beneficial amounts of vitamins and minerals. MultiChews are chewable wafers that contains a fruit and vegetable base.

Muscle MR3™ was developed after reviewing numerous clinical studies on the factors that are involved in muscle repair, recovery, and restoration. Even with proper training and nutrition, many individuals develop muscle soreness and damage. To repair soft tissue and promote muscle growth, antioxidants and anti-inflammatory factors must be involved.

Calcium is not only vital for the formation of bones and teeth, but also for the muscular repair, growth, and contraction. To promote growth and repair of muscles, Muscle MR3™ includes calcium citrate malate, a form a calcium that is highly absorbable. Calcium citrate malate helps to regulate muscle tissue and prevent lactic acid build-up, which leads to muscle soreness.

Muscle MR3™ also includes vitamin C and pueraia root, thereby forming an effective antioxidant that helps the body to neutralize dangerous free radicals. Free radicals develop in the muscle tissue due to stress. If these free radicals are not neutralized and eliminated from the system, the free radicals could damage tissue and prevent its subsequent restoration.

Muscle MR3™ also includes cayenne. A natural anti-inflammatory in cayenne helps the body to reduce muscle swelling and to promote healthy muscle growth. Cayenne acts as a natural CoX-2 inhibitor, which is an enzyme found to relieve swelling and inflammation.

The combination of the elements mentioned hereinabove, along with an activating system (e.g., the VitaCube Activating System™), promotes muscle repair, restoration, and recovery.

Pure Heat™ reduces inflammation and accelerates repair and recovery for joints and muscles.

A natural reaction to injury and infection is inflammation. Events such as sudden trauma, over training, and free radical damage may all produce inflammation in the joints and muscles.

Research has found that when an inflammation reaction takes place, co-oxygenase 2, an enzyme, is produced. Studies have shown that inhibiting this enzyme produces anti-inflammatory effects. Pure Heat™ includes three natural co-oxygenase 2 inhibitors. These inhibitors produce the same anti-inflammatory effects without the uncomfortable side effects of pharmaceuticals.

Cayenne, boswellia, and turmeric are three natural herbs that help to inhibit the production of co-oxygenase 2, thereby reducing inflammation.

Cayenne, a fiery spice from dried hot peppers, is one of the main ingredients in Pure Heat™. This herb is not only an effective CoX-2 inhibitor, but also has been shown to deplete a component of nerve calls called “substance P” that transmit pain impulses to the brain.

Boswellia is another ingredient in Pure Heat™. Boswellia helps to repair blood vessels that are commonly damaged by inflammation. Boswellia has been shown to be an effective anti-inflammatory, anti-arthritic, and antibacterial.

Turmeric is another ingredient in Pure Heat™. Free radicals that are often associated with inflammation and muscle soreness are neutralized using turmeric. Turmeric has valuable antioxidant properties, as well as being capable of aiding in the circulation of blood.

Visual Eyes™ includes carotenoids, vitamins, and minerals. More than six-million individuals are faced with macular degeneration and poor eye health. Macular degeneration one of the leading causes of blindness for individuals over the age of fifty. Dangerous free radicals are produced in the body due to stress and general daily activities. These free radicals harm cells and destroy sensitive eye layers.

Carotenoids have been identified as powerful antioxidants, protecting cells from the damage caused by free radicals. Lutein is the main carotenoid that has been associated with greater eye health and prevention of macular degeneration. Visual Eyes™ contains approximately six milligrams of lutein. Lutein promotes clear vision by absorbing the sun's harmful ultraviolet rays and neutralizing free radicals in the retina.

Visual Eyes™ also includes a combination of other vitamins and minerals which further promote antioxidant effects and supply the proper nutrients to the eye, including vitamin A, which is converted from a carotenoid, and vitamin C.

The present invention will now be illustrated by the examples hereinbelow, which are not intended to be limiting in any way.

### EXAMPLE 1

In one convenient case that is delivered to an individual's door bi-monthly are all the nutritional supplements required to meet the individual's needs. These needs are determined based on an evaluation of the individual's personal profile. When the needs are determined, they are matched with nutritional supplements or “modules” effective for satisfying those needs. Individual supplements are then combined into a “kit” which is tailored to the individual's personal needs. This kit is then delivered to the individual on a recurring basis as required (e.g., bi-monthly). As the needs of the individual change, the kit may be altered by substituting, rearranging, subdividing, or otherwise manipulating nutritional supplements.

The kit is systematically organized. The formulations are compartmentalized, with their name, purpose, ingredients, and directions for use.

Three possible levels of activity and nutritional comfort for which a kit might be designed are basic, essential, and elite. “Basic” includes four nutritional supplements and an additional nutritional supplement specifically for women. “Essentials” is designed for active individuals whose nutritional balance requires essential support, replacement of nutrients lost to exercise, and convenience for a fast-paced lifestyle. This kit includes seven nutritional supplements and a nutritional supplement specifically for women. “Elite” is designed for high-performance athletes and fitness enthusiasts. Individuals comfortable with supplementation and want to reach an optimum level of health will also benefit from the Elite level. Elite includes approximately thirteen to fifteen nutritional supplements and an additional nutritional supplement specifically for women. For males over the age of forty, a special complex for reducing an enlarged prostate and decreasing the likelihood of prostate cancer is included.

Examples of gender-specific basic, essential, and elite kits are described hereinbelow.

Male Basic VitaCube™ begins to build a core to maintaining long-term health benefits. Male Basic VitaCube™ includes four nutritional supplements: M32+™, Absorbit™, Cal/Mag+™, and CP Complex™. The four nutritional supplements are taken in the morning and evening. Absorbit™ is also taken in the afternoon. A total of nine tablets are taken throughout the day. (It should be noted that “tablet” as used herein refers to one unit of nutritional supplement. A tablet may also be referred to herein as a “pill,” “capsule,” or “vitamin.”)

Male Basic VitaCube™ is ideal for the male who is beginning to start a nutritional program and has never taken multiple nutritional supplements.

Female Basic VitaCube™ includes five nutritional supplements: M32+™, Absorbit™, Cal/Mag+™, CP Complex™, and WNB™. A total of twelve tablets are taken throughout the day, mostly in the mornings and evenings.

Male Essential VitaCube™ is designed to keep up with increasing activity, while at the same time minimizing the number of nutritional supplements needed for the increasing activity level. Male Essential VitaCube™ provides the male body with the nutritional supplements to keep up with an increasingly active lifestyle. Male Essential VitaCube™ includes seven nutritional supplements: M₃₂+™, Cal/Mag+™, Absorbit™, CP Complex™, JSH™, GC Elite™, and Ultra EFA+™. A total of sixteen tablets are taken throughout the day, mostly in the morning and evening. Absorbit™ is also taken in the afternoon.

The focus of Male Essential VitaCube™ is to provide additional benefits to the muscles, joints, ligaments, and tendons. JSH™, for cartilage repair and growth, GC Elite™, for efficient cellular metabolism, along with Ultra EFA+E™, which provides nourishing fatty acids to muscles, ligaments, and tendons, are three nutritional supplements that concentrate on recovery and repair after continual exercise. Absorbit™, for digestive health, Cal/Mag+™, for healthy bones, and CP Complex™, for further efficient cellular metabolism, further complete Male Essential VitaCube™.

Male Essential VitaCube™ is ideal for males who have taken multiple nutritional supplements before and are increasing their level of activity. If a continued exercise program is in place and a conscious effort is being taken to focus on nutrition, Male Essential VitaCube™ is an ideal program.

Female Essential VitaCube™ includes eight nutritional supplements: M32+™, Cal/Mag+™, Absorbit™, CP Complex™, WNB™, JSH™, GC Elite™, and Ultra EFA+E™. A total of twenty-one tablets are taken throughout the day, mostly in the morning and evening. Absorbit™ is also taken in the afternoon.

Female Essential VitaCube™ is ideal for a woman who is starting to slowly increase her activity level, while at the same time getting conditioned to taking more nutritional supplements.

Male Elite VitaCube™ is for a male who constantly pushes his body to the extremes to gain better performance and health. With effects such as reducing the number of dangerous free radicals and providing sustained energy, Male Elite VitaCube™ offers a complete system of nutritional supplementation.

Male Elite VitaCube™ includes eleven nutritional supplements: M32+™, Cal/Mag+™, Absorbit™, CP Complex™, JSH™, GC Elite™, Ultra EFA+E™, Q-Zyme™, AlphaNac™, AO Elite™, and ZMA Pro™. A total of twenty-eight tablets are taken throughout the day, mostly in the morning and evening. Absorbit™ is also taken in the afternoon. ZMA Pro™ is only taken at bedtime.

Male Elite VitaCube™ is ideal for a man that is looking to maximize his potential with regard to exercise and daily performance. Providing support in areas such as the immune system, digestive health, bone and muscle strength, and antioxidant production, the Male Elite VitaCube™ covers all of the bases when it comes to an active, vigorous lifestyle.

Female Elite VitaCube™ includes eleven nutritional supplements: M32+™, Cal/Mag+™, Absorbit™, CP Complex™, WNB™, JSH™, GC Elite™, Ultra EFA+E™, Q-Zyme™, AlphaNac™, and AO Elite™. A total of twenty-five tablets are taken throughout the day, mostly in the morning and evening. Absorbit™ is also taken in the afternoon.

Female Elite VitaCube™ is ideal for a woman who has started a regimen of exercise with higher than normal activity levels. Female Elite VitaCube™ provides a woman with adequate amounts of nutrients that are necessary to perform today but also build a healthy groundwork for the future.

Examples of age-specific basic, essential, and elite kits are described hereinbelow.

“Prep Basic” is directed towards young athletes from about thirteen to about twenty-one years old. Containing only the most basic nutritional supplements, Prep Basic is the first step towards proper nutritional habits.

Prep Basic includes four nutritional supplements: M32+™, Cal/Mag+™, Absorbit™, and CP Complex™. To make compliance easier, and therefore provide maximum benefits for this age group, the nutritional supplements are taken only twice a day. A total of ten tablets are taken throughout the day, in the mornings and evenings.

Prep Basic is ideal for any young adult that desires to start a program of proper nutrition but is hesitant because it is their first time taking nutritional supplements. Consuming just a few nutritional supplements in the morning and evening provides a young adult with the basic nutrients their body needs.

“Prep Essential” is designed to meet the nutritional and catalytic needs of a young adult between the ages of about thirteen to about nineteen years old.

Prep Essential includes five nutritional supplements: M32+™, Cal/Mag+™, Absorbit™, CP Complex™, and GC Elite™. Prep Essential is developed to be taken in the mornings and evenings. A total of eleven tablets are taken throughout the day.

Supplying the body with the most basic nutrients is M32+™, a highly advanced nutritional supplement. Although an emphasis has been placed on providing the body with nutritional supplements necessary for body growth, Prep Essential also focuses on improving cellular and metabolic activity. GC Elite™ is included to provide the body with metabolic support, using fat and building muscle in the most efficient way possible. To keep up with the developmental needs of this age group, Cal/Mag+™ is provided to insure proper growth of bones and muscles. Absorbit™, for digestive support, is essential because of the various types of diets that are often associated with young adults. Immune system support is given by providing the body with antioxidants in CP Complex™.

Prep Essential is ideal for young adults who have taken a concentrated focus on their nutritional needs and require high performance from their bodies.

“Prep Elite” supports high performance and body growth by providing numerous vitamins and minerals to the body. Adolescents often face the same degrees of stress with exercise and daily routines as adults. Thus, it is vital that their bodies are provided with the proper nutrition that is required for optimum performance. Being involved in multiple activities, while carrying a load of educational responsibilities, young adults demand not only excellence on the playing field but also in the classroom.

Prep Elite includes seven nutritional supplements: M32+™, JSH™, Cal/Mag+™, Absorbit™, CP Complex™, GC Elite™, and AO Elite™. A total of twelve nutritional supplements are taken throughout the day. Understanding that compliance could be a problematic issue with adolescents, the system is taken only in the mornings and evenings.

Building upon a solid core using M32+™, a multivitamin, Prep Elite addresses the needs of a high performance young adult. During the adolescent ages, growth of bone and muscle is at its most active. Thus, Cal/Mag+™ is included to insure proper development. JSH™ strengthens ligaments and tendons, while at the same time it helps to build cartilage between the joints. CP Complex™ and AO Elite™ provide antioxidants and improve circulation to aid in recovery and repair. The efficient usage of fats as energy and the improvement of cellular metabolism is provided by GC Elite™. With the varying types of foods that are often consumed by young adults, Absorbit™ is added to provide proper breakdown and support digestive health.

Prep Elite is ideal for young athletes that strive to obtain a high level of results from their training and performance. Prep Elite allows young adults to continue with an aggressive training routine and to not worry about the nutritional requirements needed for fuel.

“Elite Male Over 40” was developed with the understanding that as a male gets older, his activity level may increase and therefore more emphasis must be placed on long-term health benefits. Elite Male Over 40 contains all of the nutrients that are required to keep up with a dynamic lifestyle and to lay a foundation for better long-term health.

Elite Male Over 40 includes eleven nutritional supplements: M32+™, Cal/Mag+™, Absorbit™, CP Complex™, JSH™, GC Elite™, Ultra EFA+E™, Q-Zyme™, AlphaNac™, AO Elite™, and Complex SPP™. A total of twenty-eight tablets are taken throughout the day, mostly in the morning and evening. Absorbit™ is also taken in the afternoon.

Elite Male Over 40 is ideal for a male over the age of forty who wants to maintain an active lifestyle and insure proper long-term health. Elite Male Over 40 focuses on long-term health as well as providing immediate nutrients to keep up with exercise and fitness routines.

“Elite with Complex SPP™,” or simply “Elite Cube” is for males who are serious about advanced fitness. Elite Cube includes a variety of nutritional supplements, such as, for example, M₃₂+™, Cal/Mag+™, Absorbit™, CP Complex™, GC Elite™, Ultra EFA+E™, JSH™, AlphaNac™, AO Elite™, Q-Zyme™, ZMA Pro™, and Complex SPP™.

There are also goal-specific kits that may be provided to an individual. These kits are described hereinbelow.

Male Lean & Tone VitaCube™ is to help the male body use fat as its primary energy source and to support metabolic activity. Male Lean & Tone VitaCube™ promotes the body's ability to burn fat and also to gain the proper nutrients required to maintain a healthy lifestyle.

Male Lean & Tone VitaCube™ includes four nutritional supplements: M32+™, GC Elite™, Cal/Mag+™, and Ultra EFA+E™. A total of fifteen tablets are taken throughout the day, in the mornings and evenings.

Providing a solid multivitamin in M32+™ supplies the body with the foundation of basic nutrients needed for proper health. The weight management system is centered around the cellular metabolizing effects of GC Elite™. This nutritional supplement allows the body to use energy from its fat stores and to use the fat stores more efficiently. The body's ability to build lean body mass is enhanced with Ultra EFA+E™, while bones and muscles are strengthened by Cal/Mag+™.

Male Lean & Tone VitaCube™ is ideal for a male that would like to supplement his solid exercise program with a system of proper nutrition.

Female Lean & Tone VitaCube™ focuses on using the body's best energy store—fats. Female Lean & Tone VitaCube™ concentrates on providing proper nutrition, increased utilization of fat stores, and regulation of erratic hormonal levels that may be associated with weight management and exercise.

Female Lean & Tone VitaCube™ includes five nutritional supplements: M32+™, GC Elite™, Cal/Mag+™, Ultra EFA+E™, and WNB™. A total of sixteen tablets are taken throughout the day, in the mornings and evenings.

Providing the essential nutrients that are universal for all women, M32+™ is the core of the Female Lean & Tone VitaCube™. Cal/Mag+™ is included to address the needs that women have for healthy bones and muscles. To help develop lean, toning effects by supporting the right muscle growth, Ultra EFA+E™ is included. Supplying the body with L-Glutamine and L-Carnitine, in GC Elite™, enhances the utilization of fat for primary energy. To regulate hormonal levels that may shift due to decreased diet and increased activity, WNB™ works with the woman's body to insure positive focus.

Female Lean & Tone VitaCube™ is ideal for a woman who wants to enhance the effects of her exercise and weight management programs. Female Lean & Tone VitaCube™ includes basic nutrients for proper health, and develops a system to maximize the benefits of exercise and proper eating habits. Female Lean & Tone VitaCube™ is a total system of complete nutrition and optimum fat utilization.

Joint Health VitaCube™ is designed to focus on the special needs that are associated with joint activity. Joint Health VitaCube™ includes seven nutritional supplements: M32+™, Cal/Mag+™, GC Elite™, JSH™, Ultra EFA+E™, AlphaNac™, and CP Complex™. A total of eighteen tablets are taken throughout the day, in the mornings and evenings.

M32+™, a multivitamin, is included in Joint Health VitaCube™. Essential for strong bones and muscles, Cal/Mag+™ is included to support superior development in those areas. For repair and recovery at a cellular level, GC Elite™ allows for increased cellular metabolism and fat utilization. To directly strengthen and repair cartilage, ligaments, and tendons, glucosamine, chrondroitin, and MSM are combined in JSH™. Ultra EFA+E™ is added to increase the body's ability to build lean muscle mass. AlphaNac™ and CP Complex™ are included because they are effective antioxidants that help the body to release and neutralize free radicals associated with stress and surgery.

Joint Health VitaCube™ is ideal for individuals who are faced with uncomfortable joint pain due to the degeneration of cartilage, ligaments, tendons, and muscle. Joint Health Vitacube™ focuses on the need to provide the nutrients that are able to repair and accelerate recovery in these areas. Joint Health VitaCube™ contains the proper elements needed to support joint health care.

Each of the nutritional supplements described hereinabove may contain an activating system (e.g., the VitaCube Activating System™) to further their respective effects.

### EXAMPLE 2

An individual experienced with exercise decides to purchase a subscription for a kit from a Web site (e.g., http://www.v3s.com). First, the individual fills out a questionnaire, answering questions about his or her current health, physical dimensions, exercise experience, experience with supplementation, goals, interests, injuries or any other potentially relevant medical information. The individual's information is then transmitted to a processing center, where the data is sorted into objective health categories (e.g., height, weight, etc.). The individual's information is then analyzed (e.g., by a person trained in nutrition) to evaluate which kit or combination of nutritional supplements, exercise, and other equipment should be provided. A kit may be delivered weekly, for example, to the individual's health club, for the added convenience of storing the nutritional supplements at his or her place of exercise. No exercise program or system is provided for this individual because he or she is an experienced athlete.

### EXAMPLE 3

An individual inexperienced with health and fitness decides to purchase a subscription for a kit from his or her physician. The physician may have questionnaires available. Alternatively, the individual may have brought a questionnaire from, for example a Web site (e.g., http://www.v3s.com). With the assistance of the physician, the individual fills out the questionnaire answering questions about his or her current health, physical dimensions, exercise experience, experience with supplementation, goals, interests, injuries or any other potentially relevant medical information. The individual's information is confirmed by the physician and then transmitted to a processing center, where, for example, a computing device sorts the data into objective health categories (e.g., height, weight, etc.). The individual's subjective information is then analyzed by, for example, a person trained in nutrition to evaluate which system or combination of nutritional supplements, exercise, or other equipment should be provided. Due to this individual's inexperience with nutritional supplementation, a moderate introductory nutritional supplementation kit is prepared and delivered to the individual's home for his or her convenience and privacy. Also due to the individual's physiological inexperience with nutritional supplementation, the kit is prepared and delivered monthly. An exercise program is formulated and included with the monthly delivery, with the exercise program being open-ended and designed for monthly augmentation based on progress.

### EXAMPLE 4

A professional, collegiate or other type of sports team decides to purchase a subscription to a kit to achieve team goals. The individual (e.g., coach, trainer, etc.) conceptualizes the team's goals (e.g., individually, in team subgroups, or for the team as a whole). Due to the team's complex requirements, this particular kit is delivered semi-monthly to the team headquarters for distribution. No exercise program or system is provided for the team because the team currently has a strict regimen in place.

### EXAMPLE 5

An individual interested in improving his current exercise program obtains a questionnaire from a retail store. The individual's subjective information is then analyzed, for example, by a computing device. A person trained in nutrition evaluates which kit or combination of nutritional supplements, exercise, or other equipment should be provided. Due to this individual's moderate requirements and for his or her convenience, this particular kit is delivered monthly, for example, to his or her office, for the convenience of storing the nutritional supplements at the workplace. An exercise program is provided with this individual's program.

### EXAMPLE 6

A nutritional supplement distributor or manufacturer groups nutritional supplements into categories or groups assigned to relieve specific maladies or enhance specific types of performance. These groups can then be flexibly and easily assembled, by the manufacturer, distributor or other entity in the chain of distribution of the nutritional supplements, or by the individual consumer himself, into kits based on individual or group preferences.

It will be understood that the foregoing is only illustrative of the principles of the invention, and that still other modifications can be made by those skilled in the art without departing from the scope and spirit of the invention.

What is claimed is:

1. A method for designing a customized nutritional supplement regime and delivering the customized nutritional supplement regime to an individual, the method comprising:
receiving information from the individual, wherein at least a portion of the information concerns personal information about the individual;
creating a nutritional supplement regime that includes a plurality of nutritional supplements that are selected based on the received information; and
providing the nutritional supplement regime to the individual.

2. The method of claim 1 further comprising:
providing the individual with a questionnaire; and
wherein the receiving further comprises receiving information as inputted into the questionnaire by the individual.

3. The method of claim 2 further comprising:
allowing the individual to access the questionnaire via a public switched telephone network.

4. The method of claim 2 further comprising:
allowing the individual to access the questionnaire via the Internet.

5. The method of claim 1 further comprising:
conducting an interview with the individual; and
wherein the receiving further comprises receiving information as provided during the interview by the individual.

6. The method of claim 1 further comprising:
conducting a telephonic interview with the individual; and
wherein the receiving further comprises receiving information as provided during the telephonic interview by the individual.

7. The method of claim 1 wherein the providing the nutritional supplement regime to the individual further comprises providing the nutritional supplement regime to the individual in a case, wherein the case has a cover, a compartment, and a plurality of partitions that separate the compartment into a plurality of chambers, and wherein each nutritional supplement of the plurality of nutritional supplements is held in a chamber of the plurality of chambers.

8. The method of claim 1 wherein at least a portion of the information concerns nutritional habits of the individual.

9. The method of claim 1 wherein at least a portion of the information concerns exercise habits of the individual.

10. The method of claim 1 wherein at least a portion of the information concerns health information of the individual.

11. The method of claim 1 wherein at least a portion of the information concerns personal goals of the individual.

12. A system for designing a customized nutritional supplement regime and delivering the customized nutritional supplement regime to an individual, the system comprising:
means for receiving information from the individual, wherein at least a portion of the information concerns personal information about the individual;
means for creating a nutritional supplement regime that includes a plurality of nutritional supplements that are selected based on the received information; and
means for providing the nutritional supplement regime to the individual.

13. The system of claim 12 further comprising:
means for providing the individual with a questionnaire; and
wherein the means for receiving further comprises means for receiving information as inputted into the questionnaire by the individual.

14. The system of claim 13 further comprising:
means for allowing the individual to access the questionnaire via a public switched telephone network.

15. The system of claim 13 further comprising:
means for allowing the individual to access the questionnaire via the Internet.

16. The system of claim 12 further comprising:
means for conducting an interview with the individual; and
wherein the means for receiving further comprises means for receiving information as provided during the interview by the individual.

17. The system of claim 12 further comprising:
means for conducting a telephonic interview with the individual; and
wherein the means for receiving further comprises means for receiving information as provided during the telephonic interview by the individual.

18. The system of claim 12 wherein the means for providing the nutritional supplement regime to the individual further comprises means for providing the nutritional supplement regime to the individual in a case, wherein the case has a cover, a compartment, and a plurality of partitions that separate the compartment into a plurality of chambers, and wherein each nutritional supplement of the plurality of nutritional supplements is held in a chamber of the plurality of chambers.

19. The system of claim 12 wherein at least a portion of the information concerns nutritional habits of the individual.

20. The system of claim 12 wherein at least a portion of the information concerns exercise habits of the individual.

21. The system of claim 12 wherein at least a portion of the information concerns health information of the individual.

22. The system of claim 12 wherein at least a portion of the information concerns personal goals of the individual.

23. A system for designing a customized nutritional supplement regime and delivering the customized nutritional supplement regime to an individual using a nutritional supplement questionnaire application, the system comprising:
a server on which the nutritional supplement questionnaire application resides;
a communications network, wherein the communications network is in communication with server; and
a workstation, wherein the workstation is in communication with the communications network; and
wherein the server is configured to provide the workstation with a questionnaire via the communications network, wherein the workstation receives information from the individual as inputted into the questionnaire, wherein at least a portion of the information concerns personal information about the individual, wherein a nutritional supplement regime is created that includes a plurality of nutritional supplements that are selected based on the information, and wherein the nutritional supplement regime is provided to the individual.

24. The system of claim 23 further comprising a case, wherein the case has a cover, a compartment, and a plurality of partitions that separate the compartment into a plurality of chambers, and wherein each nutritional supplement of the plurality of nutritional supplements is held in a chamber of the plurality of chambers; and
wherein the nutritional supplement regime is provided to the individual in the case.

25. The system of claim 23 wherein at least a portion of the information concerns nutritional habits of the individual.

26. The system of claim 23 wherein at least a portion of the information concerns exercise habits of the individual.

27. The system of claim 23 wherein at least a portion of the information concerns health information of the individual.

28. The system of claim 23 wherein at least a portion of the information concerns personal goals of the individual.
